(19) United States
(12) Patent Application Publication
(10) Pub. No.: US 2025/0247719 A1
(43) Pub. Date: Jul. 31, 2025

(54) METHODS AND APPARATUSES FOR AN AI OR ML BASED CCO MECHANISM

(71) Applicant: Lenovo (Beijing) Limited, Beijing (CN)

(72) Inventors: Le Yan, Shanghai (CN); Mingzeng Dai, Shanghai (CN); Congchi Zhang, Shanghai (CN); Yibin Zhuo, Shanghai (CN)

(73) Assignee: Lenovo (Beijing) Limited, Beijing (CN)

(21) Appl. No.: 18/854,729

(22) PCT Filed: Apr. 14, 2022
(86) PCT No.: PCT/CN2022/086836

§ 371 Date: Oct. 7, 2024

(51) Int. Cl. H04W 24/02; H04L 41/16; H04W 16/26; H04W 88/08

(52) U.S. Cl. CPC H04W 24/02; H04L 41/16; H04W 16/26; H04W 88/085

(57) ABSTRACT

Provided are methods and apparatuses for an artificial intelligence (AI) or machine learning (ML) based capacity and coverage optimization (CCO) mechanism. A network device (e.g., a RAN node or a centralized unit (CU)) includes a transceiver and a processor coupled to the transceiver; and the processor is configured: to obtain inference input data associated with CCO; to perform an inference operation of a processing model for CCO based on the inference input data; and to generate output data of the inference operation of the processing model for CCO.

### TECHNICAL FIELD

Embodiments of the present application generally relate to wireless communication technology, in particular to methods and apparatuses for an artificial intelligence (AI) or machine learning (ML) based capacity and coverage optimization (CCO) mechanism.

### BACKGROUND

In the 3rd Generation Partnership Project (3GPP) new radio (NR), an objective of a capacity and coverage optimization (CCO) function is to detect and mitigate coverage and cell edge interference issues. CCO is used for dynamic coverage changes with an index-based solution for coverage switching among deployment options. Currently, in a wireless communication system or the like, details regarding an AI/ML based CCO mechanism have not been specifically discussed yet.

### SUMMARY

Some embodiments of the present application provide a network device (e.g., a RAN node or a centralized unit (CU)). The network device includes a transceiver and a processor coupled to the transceiver; and the processor is configured: to obtain inference input data associated with capacity and coverage optimization (CCO); to perform an inference operation of a processing model for CCO based on the inference input data; and to generate first output data of the inference operation of the processing model for CCO.

In some embodiments, the first output data includes at least one of: a set of first CCO issues predicted by the network device; a set of first predicted cells in which there is an issue within the set of first CCO issues; a set of first predicted synchronization signal blocks (SSBs) in which there is the issue within the set of first CCO issues; first predicted validity time for an issue within the set of first CCO issues; second predicted validity time for a cell within the set of first predicted cells; or third predicted validity time for a SSB within the set of first predicted SSBs.

In some embodiments, the issue within the set of first CCO issues is related to at least one of: coverage of the cell within the set of first predicted cells, or a cell edge capacity of the cell within the set of first predicted cells.

In some embodiments, at least two of the first predicted validity time, the second predicted validity time, or the third predicted validity time are identical or different.

In some embodiments, the processor of the network device is configured to generate second output data of the inference operation of the processing model for CCO.

In some embodiments, the network device is a CU, and the processor of the CU is configured to transmit at least one of the first output data or the second output data via the transceiver to a distributed unit (DU) managed by the CU.

In some embodiments, the processor of the network device is configured to transmit at least one of the first output data or the second output data via the transceiver to a neighbour network device or a neighbour centralized unit (CU).

In some embodiments, the network device is a CU, and the processor of the CU is configured: to transmit the first output data via the transceiver to a DU managed by the CU; and to receive second output data via the transceiver from the DU managed by the CU.

In some embodiments, the second output data includes at least one of: a set of first predicted cell coverage modification configuration(s); a set of first predicted SSB coverage modification configuration(s); fourth predicted validity time for a configuration within the set of first predicted cell coverage modification configuration(s); or fifth predicted validity time for a configuration within the set of first predicted SSB coverage modification configuration(s).

In some embodiments, the configuration within the set of first predicted cell coverage modification configuration(s) includes at least one of: a predicted cell coverage state; a predicted cell deployment status indicator; or predicted cell replacing information.

In some embodiments, the configuration within the set of first predicted SSB coverage modification configuration(s) includes at least one of: a predicted SSB coverage state; a predicted SSB deployment status indicator; or predicted SSB replacing information.

In some embodiments, the fourth predicted validity time and the fifth predicted validity time are identical or different.

In some embodiments, the inference input data is local inference input data; or the inference input data is received via the transceiver from at least one of: a user equipment (UE), a neighbour network device, a neighbour centralized unit (CU), at least one distributed units (DUs) managed by the neighbour CU, or at least one DU managed by the network device when the network device is a CU.

In some embodiments, the inference input data received from the UE includes at least one of: location information of the UE; mobility history information of the UE; measurement results from the UE; a connection establishment failure (CEF) report from the UE; a radio access (RA) report from the UE; or a radio link failure (RLF) report from the UE.

In some embodiments, the inference input data received from at least one of the neighbour network device, the neighbour CU, or the at least one DU managed by the neighbour CU includes at least one of: a current resource status; a historical resource status; or a predicted resource status.

In some embodiments, the local inference input data or the inference input data received from the at least one DU managed by the network device includes at least one of: a historical resource status; a current resource status; a predicted resource status; a trajectory prediction of the UE; historical traffic of the UE; current traffic of the UE; or predicted traffic of the UE.

In some embodiments, the processor of the network device is configured: to transmit processing model performance feedback information via the transceiver to an operation administration and maintenance (OAM) entity; or to receive the processing model performance feedback information via the transceiver from at least one of: a neighbour network device, a neighbour centralized unit (CU), at least one distributed unit (DU) managed by the neighbour CU, or at least one DU managed by the network device when the network device is a CU.

In some embodiments, the processing model performance feedback information includes at least one of: a local resource status; at least one local system key performance indicator (KPI); a neighbouring resource status; or at least one neighbouring system KPI.

Some embodiments of the present application provide a method, which may be performed by a network device (e.g., a RAN node or a CU). The method includes: obtaining inference input data associated with capacity and coverage optimization (CCO); performing an inference operation of a processing model for CCO based on the inference input data; and generating first output data of the inference operation of the processing model for CCO.

Some embodiments of the present application provide a network device (e.g., a RAN node or a CU). The network device includes a transceiver and a processor coupled to the transceiver; and the processor is configured: to receive at least one of first output data of capacity and coverage optimization (CCO) or second output data of CCO via the transceiver from a neighbour network device; or to receive the at least one of the first output data of CCO or the second output data of CCO via the transceiver from a neighbour centralized unit (CU), wherein the first output data of CCO is associated with an inference operation of a processing model of the neighbour network device or the neighbour CU, and wherein the second output data of CCO is associated with the inference operation of the processing model of the neighbour network device or the neighbour CU or associated with an inference operation of a processing model of a distributed unit (DU) managed by the neighbour CU.

In some embodiments, the first output data of CCO includes at least one of: a set of first CCO issues predicted by the neighbour network device or the neighbour CU; a set of first predicted cells in which there is an issue within the set of first CCO issues; a set of first predicted synchronization signal blocks (SSBs) in which there is the issue within the set of first CCO issues; first predicted validity time for the issue within the set of first CCO issues; second predicted validity time for a cell within the set of first predicted cells; or third predicted validity time for a SSB within the set of first predicted SSBs.

In some embodiments, the issue within the set of first CCO issues is related to at least one of: coverage of the cell within the set of first predicted cells; or a cell edge capacity of the cell within the set of first predicted cells.

In some embodiments, at least two of the first predicted validity time, the second predicted validity time, or the third predicted validity time are identical or different.

In some embodiments, the second output data of CCO includes at least one of: a set of first predicted cell coverage modification configuration(s); a set of first predicted SSB coverage modification configuration(s); fourth predicted validity time for a configuration within the set of first predicted cell coverage modification configuration(s); or fifth predicted validity time for a configuration within the set of first predicted SSB coverage modification configuration(s).

In some embodiments, the fourth predicted validity time and the fifth predicted validity time are identical or different.

In some embodiments, the network device is a CU, and wherein the processor of the CU is configured to transmit at least one of the first output data of CCO or the second output data of CCO to a distributed unit (DU) managed by the CU.

In some embodiments, the processor of the network device is configured: to perform an inference operation of a processing model for CCO; and to generate at least one of third output data of CCO or fourth output data of CCO, wherein the third output data of CCO and the fourth output data of CCO are associated with the inference operation of the processing model of the network device.

In some embodiments, the network device is a CU, and the processor of the CU is configured to transmit the at least one of the third output data of CCO or the fourth output data of CCO to a DU managed by the CU.

In some embodiments, the third output data of CCO includes at least one of: a set of second CCO issues predicted by the network device; a set of second predicted cells in which there is an issue within the set of second CCO issues; a set of second predicted synchronization signal blocks (SSBs) in which there is the issue within the set of second CCO issues; sixth predicted validity time for the issue within the set of second CCO issues; seventh predicted validity time for a cell within the set of second predicted cells; or eighth predicted validity time for a SSB within the set of second predicted SSBs.

In some embodiments, at least two of the sixth predicted validity time, the seventh predicted validity time, or the eighth predicted validity time are identical or different.

In some embodiments, the fourth output data of CCO includes at least one of: a set of second predicted cell coverage modification configuration(s); a set of second predicted SSB coverage modification configuration(s); ninth predicted validity time for a configuration within the set of second predicted cell coverage modification configuration(s); or tenth predicted validity time for a configuration within the set of second predicted SSB coverage modification configuration(s).

In some embodiments, the ninth predicted validity time and the tenth predicted validity time are identical or different.

In some embodiments, the network device is a CU, and the processor of the CU is configured to receive fifth output data of CCO from a DU managed by the CU, wherein the fifth output data of CCO is associated with the inference operation of the processing model of the DU.

In some embodiments, the fifth output data of CCO includes at least one of: a set of third predicted cell coverage modification configuration(s) predicted by the DU managed by the CU; a set of third predicted SSB coverage modification configuration(s) predicted by the DU managed by the CU; eleventh predicted validity time for a configuration within the set of third predicted cell coverage modification configuration(s); or twelfth predicted validity time for a configuration within the set of third predicted SSB coverage modification configuration(s).

In some embodiments, the eleventh predicted validity time and the twelfth predicted validity time are identical or different.

In some embodiments, at least one of the configuration within the set of first predicted cell coverage modification configuration(s), the configuration within the set of second predicted cell coverage modification configuration(s), or the configuration within the set of third predicted cell coverage modification configuration(s) includes at least one of: a predicted cell coverage state; a predicted cell deployment status indicator; or predicted cell replacing information.

In some embodiments, at least one of the configuration within the set of first predicted SSB coverage modification configuration(s), the configuration within the set of second predicted SSB coverage modification configuration(s), or the configuration within the set of third predicted SSB coverage modification configuration(s) includes at least one of: a predicted SSB coverage state; a predicted SSB deployment status indicator; or predicted SSB replacing information.

In some embodiments, the processor of the network device is configured to transmit inference input data associated with CCO via the transceiver to the neighbour network device or the neighbour CU.

In some embodiments, the processor of the network device is configured to generate the inference input data.

In some embodiments, the network device is a CU, and the inference input data is received from a distributed unit (DU) managed by the network device.

In some embodiments, the inference input data includes at least one of: a current resource status; a historical resource status; or a predicted resource status.

In some embodiments, the processor of the network device is configured to transmit processing model performance feedback information via the transceiver to an operation administration and maintenance (OAM) entity, the neighbour network device, or the neighbour CU.

In some embodiments, the processing model performance feedback information includes at least one of: a local resource status; at least one local system key performance indicator (KPI); a neighbouring resource status; or at least one neighbouring system KPI.

Some embodiments of the present application provide a method, which may be performed by a network device (e.g., a RAN node or a CU). The method includes: receiving at least one of first output data of capacity and coverage optimization (CCO) or second output data of CCO from a neighbour network device; or receiving the at least one of the first output data of CCO or the second output data of CCO from a neighbour centralized unit (CU), wherein the first output data of CCO is associated with an inference operation of a processing model of the neighbour network device or the neighbour CU, and wherein the second output data of CCO is associated with the inference operation of the processing model of the neighbour network device or the neighbour CU or associated with an inference operation of a processing model of a distributed unit (DU) managed by the neighbour CU.

Some embodiments of the present application provide a distributed unit (DU). The DU includes a transceiver and a processor coupled to the transceiver; and the processor is configured to receive first output data of capacity and coverage optimization (CCO) via the transceiver from a centralized unit (CU), wherein the DU is managed by the CU, and wherein the first output data of CCO is associated with an inference operation of a processing model of the CU.

In some embodiments, the first output data of CCO includes at least one of: a set of first CCO issues predicted by the CU; a set of first predicted cells in which there is an issue within the set of first CCO issues; a set of first predicted synchronization signal blocks (SSBs) in which there is the issue within the set of first CCO issues; first predicted validity time for the issue within the set of first CCO issues; second predicted validity time for a cell within the set of first predicted cells; or third predicted validity time for a SSB within the set of first predicted SSBs.

In some embodiments, the issue within the set of first CCO issues is related to at least one of: coverage of the cell within the set of first predicted cells, or a cell edge capacity of the cell within the set of first predicted cells.

In some embodiments, at least two of the first predicted validity time, the second predicted validity time, or the third predicted validity time are identical or different.

In some embodiments, the processor of the DU is configured to receive second output data of CCO via the transceiver from the CU, wherein the second output data of CCO is associated with the inference operation of the processing model of the CU, and the second output data of CCO includes at least one of: a set of first predicted cell coverage modification configuration(s); a set of first predicted SSB coverage modification configuration(s); fourth predicted validity time for a cell within the set of first predicted cell coverage modification configuration(s); or fifth predicted validity time for a SSB within the set of first predicted SSB coverage modification configuration(s).

In some embodiments, the fourth predicted validity time and the fifth predicted validity time are identical or different.

In some embodiments, the processor of the DU is configured: to perform an inference operation of a processing model for CCO; and to generate third output data of CCO, wherein the third output data of CCO is associated with the inference operation of the processing model of the DU.

In some embodiments, the processor of the DU is configured to transmit the third output data of CCO to the CU.

In some embodiments, the third output data of CCO includes at least one of: a set of second predicted cell coverage modification configuration(s) predicted by the DU; a set of second predicted SSB coverage modification configuration(s) predicted by the DU; sixth predicted validity time for a cell within the set of second predicted cell coverage modification configuration(s); or seventh predicted validity time for a SSB within the set of second predicted SSB coverage modification configuration(s).

In some embodiments, the sixth predicted validity time and the seventh predicted validity time are identical or different.

In some embodiments, at least one of the configuration within the set of first predicted cell coverage modification configuration(s) or the configuration within the set of second predicted cell coverage modification configuration(s) includes at least one of: a predicted cell coverage state; a predicted cell deployment status indicator; or predicted cell replacing information.

In some embodiments, at least one of the configuration within the set of first SSB coverage modification configuration(s) or the configuration within the set of second SSB coverage modification configuration(s) includes at least one of: a predicted SSB coverage state; a predicted SSB deployment status indicator; or predicted SSB replacing information.

In some embodiments, the processor of the DU is configured to transmit processing model performance feedback information via the transceiver to an operation administration and maintenance (OAM) entity or the CU.

In some embodiments, the processing model performance feedback information includes at least one of: a local resource status; at least one local system key performance indicator (KPI); a neighbouring resource status; or at least one neighbouring system KPI.

Some embodiments of the present application provide a method, which may be performed by a DU. The method includes: receiving first output data of capacity and coverage optimization (CCO) from a centralized unit (CU), wherein the DU is managed by the CU, and wherein the first output data of CCO is associated with an inference operation of a processing model of the CU.

Some embodiments of the present application provide a distributed unit (DU). The DU includes a transceiver and a processor coupled to the transceiver; and the processor is configured to receive at least one of first output data of capacity and coverage optimization (CCO) or second output data of the CCO via the transceiver from a centralized unit (CU), wherein the DU is managed by the CU, wherein the first output data of CCO is associated with an inference operation of a processing model of a neighbour network device or a neighbour CU, and wherein the second output data of CCO is associated with the inference operation of the processing model of the neighbour network device or the neighbour CU or associated with an inference operation of a processing model of a distributed unit (DU) managed by the neighbour CU.

In some embodiments, the first output data of CCO includes at least one of: a set of first CCO issues predicted by the neighbour network device or the neighbour CU; a set of first predicted cells in which there is an issue within the set of first CCO issues; a set of first predicted synchronization signal blocks (SSBs) in which there is the issue within the set of first CCO issues; first predicted validity time for the issue within the set of first CCO issues; second predicted validity time for a cell within the set of first predicted cells; or third predicted validity time for a SSB within the set of first predicted SSBs.

In some embodiments, the issue within the set of first CCO issues is related to at least one of: coverage of the cell within the set of first predicted cells; or a cell edge capacity of the cell within the set of first predicted cells.

In some embodiments, at least two of the first predicted validity time, the second predicted validity time, or the third predicted validity time are identical or different.

In some embodiments, the second output data of CCO includes at least one of: a set of first predicted cell coverage modification configuration(s); a set of first SSB coverage modification configuration(s); fourth predicted validity time for a cell within the set of first predicted cell coverage modification configuration(s); or fifth predicted validity time for a SSB within the set of first SSB coverage modification configuration(s).

In some embodiments, the fourth predicted validity time and the fifth predicted validity time are identical or different.

In some embodiments, the processor of the DU is configured to receive at least one of third output data of CCO or fourth output data of CCO via the transceiver from the CU, wherein the third output data of CCO and the fourth output data of CCO are associated with an inference operation of a processing model of the CU.

In some embodiments, the third output data of CCO includes at least one of: a set of second CCO issues predicted by the CU; a set of second predicted cells in which there is an issue within the set of second CCO issues; a set of second predicted synchronization signal blocks (SSBs) in which there is the issue within the set of second CCO issues; sixth predicted validity time for the issue within the set of second CCO issues; seventh predicted validity time for a cell within the set of second predicted cells; or eighth predicted validity time for a SSB within the set of second predicted SSBs.

In some embodiments, at least two of the sixth predicted validity time, the seventh predicted validity time, or the eighth predicted validity time are identical or different.

In some embodiments, the fourth output data includes at least one of: a set of second predicted cell coverage modification configurations predicted by the CU; a set of second predicted SSB coverage modification configurations predicted by the CU; ninth predicted validity time for a configuration within the set of second predicted cell coverage modification configurations; or tenth predicted validity time for a configuration within the set of second predicted SSB coverage modification configurations.

In some embodiments, the ninth predicted validity time and the tenth predicted validity time are identical or different.

In some embodiments, the processor of the DU is configured: to perform an inference operation of a processing model for CCO; and to generate fifth output data of CCO, wherein the fifth output data of CCO is associated with an inference operation of a processing model of the DU.

In some embodiments, the processor of the DU is configured to transmit the fifth output data of CCO to the CU

In some embodiments, the fifth output data of CCO includes at least one of: a set of third predicted cell coverage modification configuration(s) predicted by the DU; a set of third predicted SSB coverage modification configuration(s) predicted by the DU; eleventh predicted validity time for a configuration within the set of third predicted cell coverage modification configuration(s); or twelfth predicted validity time for a configuration within the set of third predicted SSB coverage modification configuration(s).

In some embodiments, the eleventh predicted validity time and the twelfth predicted validity time are identical or different.

In some embodiments, at least one of the configuration within the set of first predicted cell coverage modification configuration(s), the configuration within the set of second predicted cell coverage modification configuration(s), or the configuration within the set of third predicted cell coverage modification configurations includes at least one of: a predicted cell coverage state; a predicted cell deployment status indicator; or predicted cell replacing information.

In some embodiments, at least one of the configuration within the set of first predicted SSB coverage modification configuration(s), the configuration within the set of second predicted SSB coverage modification configuration(s), or the configuration within the set of third predicted SSB coverage modification configurations includes at least one of: a predicted SSB coverage state; a predicted SSB deployment status indicator; or predicted SSB replacing information.

In some embodiments, the processor of the DU is configured to transmit processing model performance feedback information via the transceiver to an operation administration and maintenance (OAM) entity, the neighbour network device, or the neighbour CU.

In some embodiments, the processing model performance feedback information includes at least one of: a local resource status; at least one local system key performance indicator (KPI); a neighbouring resource status; or at least one neighbouring system KPI.

Some embodiments of the present application provide a method, which may be performed by a DU. The method includes: receiving at least one of first output data of capacity and coverage optimization (CCO) or second output data of CCO from a centralized unit (CU), wherein the DU is managed by the CU, wherein the first output data of CCO is associated with an inference operation of a processing model of a neighbour network device or a neighbour CU, and wherein the second output data of CCO is associated with the inference operation of the processing model of the neighbour network device or the neighbour CU or associated with an inference operation of a processing model of a distributed unit (DU) managed by the neighbour CU.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a network device (e.g., a RAN node, or a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates an exemplary functional framework for RAN intelligence in accordance with some embodiments of the present application.

FIG. 1B illustrates an exemplary flow chart for performing an inference operation for CCO in accordance with some embodiments of the present application.

FIG. 2 illustrates a flow chart of an exemplary procedure of wireless communications in accordance with some embodiments of the present application.

FIG. 3 illustrates a flow chart of an exemplary procedure of wireless communications in accordance with some embodiments of the present application.

FIG. 4 illustrates a flow chart of an exemplary procedure of wireless communications in accordance with some embodiments of the present application.

FIG. 5 illustrates a flow chart of an exemplary procedure of wireless communications in accordance with some embodiments of the present application.

FIG. 6 illustrates a flow chart of an exemplary procedure of wireless communications in accordance with some embodiments of the present application.

FIG. 7 illustrates a flow chart of an exemplary procedure of wireless communications in accordance with some embodiments of the present application.

FIG. 8 illustrates an exemplary block diagram of an apparatus for an AI/ML based CCO mechanism in accordance with some embodiments of the present application.

FIG. 9 illustrates a further exemplary block diagram of an apparatus for an AI/ML based CCO mechanism in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

In general, in a functional framework for radio access network (RAN) intelligence, there may be following modules or functions:
(1) Data collection: Data collected from the network nodes, management entity or UE, as a basis for AI/ML model training, data analytics and inference.
(2) AI/ML Model: A data driven algorithm by applying machine learning techniques that generates a set of outputs consisting of predicted information and/or decision parameters, based on a set of inputs.
(3) AI/ML Training: An online or offline process to train an AI/ML model by learning features and patterns that best present data and get the trained AI/ML model for inference.
(4) AI/ML Inference: A process of using a trained AI/ML model to make a prediction or guide the decision based on collected data and AI/ML model.

The following high-level principles may be applied for AI-enabled RAN intelligence:
(1) The detailed AI/ML algorithms and models for use cases are implementation specific and out of RAN3 scope.
(2) The study focuses on AI/ML functionality and corresponding types of inputs/outputs.
(3) The input/output and the location of the Model Training and Model Inference function should be studied case by case.
(4) The study focuses on the analysis of data needed at the Model Training function from Data Collection, while the aspects of how the Model Training function uses inputs to train a model are out of RAN3 scope.
(5) The study focuses on the analysis of data needed at the Model Inference function from Data Collection, while the aspects of how the Model Inference function uses inputs to derive outputs are out of RAN3 scope.
(6) Where AI/ML functionality resides within the current RAN architecture, depends on deployment and on the specific use cases.
(7) The Model Training and Model Inference functions should be able to request, if needed, specific information to be used to train or execute the AI/ML algorithm and to avoid reception of unnecessary information. The nature of such information depends on the use case and on the AI/ML algorithm.
(8) The Model Inference function should signal the outputs of the model only to nodes that have explicitly requested them (e.g., via subscription), or nodes that take actions based on the output from Model Inference.
(9) An AI/ML model used in a Model Inference function has to be initially trained, validated and tested by the Model Training function before deployment.

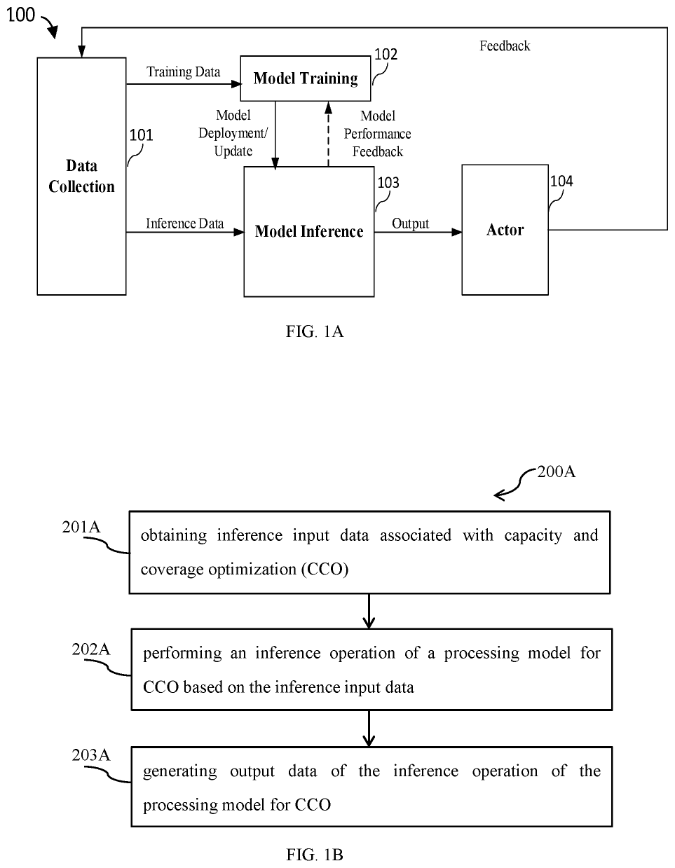

FIG. 1A illustrates an exemplary functional framework 100 for RAN intelligence in accordance with some embodiments of the present application. The exemplary functional framework 100 includes following functions.

Data Collection 101 is a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, output from an AI/ML model. As shown in FIG. 1A, Data Collection 101 outputs:
(1) Training Data: Data needed as input for the AI/ML Model Training function.
(2) Inference Data: Data needed as input for the AI/ML Model Inference function.

Model Training 102 is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required. Model Training 102 outputs “Model Deployment/Update”, which may be used to initially deploy a trained, validated, and tested AI/ML model to the Model Inference function or to deliver an updated model to the Model Inference function.

Model Inference 103 is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required. “Output” of Model Inference 103 is the inference output of the AI/ML model produced by a Model Inference function. Details of inference output are use case specific.

“Model Performance Feedback” from Model Inference 103 to Model Training 102 may be used for monitoring the performance of the AI/ML model, when available.

Actor 104 is a function that receives the output from the Model Inference function and triggers or performs corresponding actions. The Actor may trigger actions directed to other entities or to itself. “Feedback” of Actor 104 is information that may be needed to derive training data, inference data or to monitor the performance of the AI/ML Model and its impact to the network through updating of KPIs and performance counters.

Currently, in 3GPP R17, CCO is a function to detect and mitigate coverage and cell edge interference issues. AI/ML aims to study the functional framework for RAN intelligence enabled by further enhancement of data collection through use cases, examples, and etc. and identify the potential standardization impacts on current NG-RAN nodes and interfaces. In 3GPP R17, AI/ML based use cases including energy saving, load balancing, and traffic steering/mobility optimization are specified in 3GPP, but other use cases are not precluded.

In a CCO mechanism, each NG-RAN node may be configured with alternative coverage modification configuration(s) by OAM. The alternative coverage modification configuration(s) contain relevant radio parameters and may also include a range for how each parameter is allowed to be adjusted.

An NG-RAN node may autonomously adjust within and switch between coverage modification configuration(s). When a change is executed, a NG-RAN node may notify its neighbour NG-RAN nodes using the NG-RAN NODE CONFIGURATION UPDATE message with the set of cells and SSBs with modified coverage included. The list contains the CGI of each modified cell with its coverage state indicator and optionally the SSB index of each modified SSB with its coverage state indicator.

The indicator may be used at the receiving NG-RAN node to adjust the functions of the mobility robustness optimisation (MRO), e.g., by using the indicator to retrieve a previously stored MRO state. The indicator may also be used at the receiving NG-RAN node to adopt CCO configurations matching with neighbouring cells configurations.

If the list includes an indication about planned reconfiguration and possibly a list of replacing cells, the receiving NG-RAN node may use this to avoid connection or re-establishment failures during the reconfiguration. Also, if the sending NG-RAN node adds cells in inactive state, the receiving NG-RAN node may use this information to avoid connection or re-establishment failures. The receiving NG-RAN node may also use the notification to reduce the impact on mobility. The receiving NG-RAN node should avoid triggering handovers towards cell(s) that are indicated to be inactive.

Embodiments of the present application aim to study an AI/ML based CCO mechanism to improve performance of CCO. AI/ML based CCO mechanism may include AI/ML based mechanism for coverage optimization and/or AI/ML based mechanism for capacity optimization. For example, some embodiments of the present application study: which node performs AI/ML model training for CCO; which node performs AI/ML model inference for CCO; what's inference input (i.e., inference data) for AI/ML based CCO; and what's inference output for AI/ML based CCO.

In some embodiments of the present application, AI/ML model training for CCO is performed in an OAM entity or a RAN node, and AI/ML model inference for CCO is performed in a RAN node. For example, based on inference input from a UE, a neighbor RAN node and local input data, a serving RAN node predicts CCO issue(s) and cell/SSB coverage modification configuration(s) together with optional predicted validity time to solve the predicted issue(s). The serving RAN node may send the predicted CCO information to the neighbor RAN node. A neighbor RAN node may predict whether there is any CCO issue locally due to predicted cell/SSB coverage modification configuration(s) in the serving RAN node; and if yes, the neighbor RAN node also predicts its cell/SSB coverage modification configuration(s) to fit to the predicted cell/SSB coverage modification configuration(s) in the serving RAN node.

In some embodiments of the present application, AI/ML model training for CCO is performed in an OAM entity or a CU, while AI/ML model inference for CCO is performed in a CU and a DU. For example, based on inference input from a UE, a neighbor CU/DU and a local CU/DU, a serving CU predicts CCO issue(s), and sends the predicted CCO issue(s), a set of affected cell(s), a set of affected SSB(s) together with optional predicted validity time to its managed DU(s). A DU managed by the serving CU predicts cell/SSB coverage modification configuration(s) to solve the predicted CCO issue(s), and sends the predicted cell/SSB coverage modification configuration(s) to the serving CU. A neighbor DU or a DU managed by the serving CU but excluding the serving DU is informed of the predicted cell/SSB coverage modification configuration(s) which is predicted by the DU managed by the serving CU, and the neighbor DU or the DU managed by the serving CU but excluding the serving DU can predict its own cell/SSB coverage modification configuration(s) to fit to the predicted CCO information in the serving CU or the DU managed by the serving CU.

In some embodiments of the present application, AI/ML model training for CCO is performed in an OAM entity or a CU, while AI/ML model inference for CCO is performed in a CU. For example, based on inference input from a UE, a neighbor CU/DU and a local CU/DU, a serving CU predicts CCO issue(s) and cell/SSB coverage modification configuration(s) to solve the predicted CCO issue(s), and sends the predicted CCO issue(s), predicted cell/SSB coverage modification configuration(s) together with optional predicted validity time to its managed DU and a neighbor CU. A neighbor DU or a DU managed by the serving CU but excluding the serving DU is informed of the predicted CCO issue(s) and predicted cell/SSB coverage modification configuration(s) which is predicted by the serving CU, and the neighbor DU or the DU managed by the serving CU but excluding the serving DU can fit to the predicted CCO information in the serving CU.

In the embodiments of the present application, a serving DU is a DU manages the serving cell. A local CU or a serving CU is a CU manages the serving DU. A neighbour CU is a CU neighbouring to the serving CU. A neighbour DU is a DU managed by the neighbour CU. A local DU is a DU managed by the Local/Serving CU.

In the embodiments of the present application, a resource status may also be named as load information or the like. As specified in TS38.423, a resource status or load information may include following information elements (IEs): Radio Resource Status, number of RRC connections, number of Active UEs, and etc. For example, the Radio Resource Status IE indicates the usage of the PRBs per cell and per SSB area for all traffic in Downlink and Uplink and the usage of PDCCH CCEs for Downlink and Uplink scheduling.

In some embodiments of the present application (e.g., any of FIGS. 1B-7), a UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. The UE may include a portable wireless communication device, a smart phone, a cellular telephone, a flip phone, a device having a subscriber identity module, a personal computer, a selective call receiving circuitry, or any other device that is capable of sending and receiving communication signals on a wireless network. The UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present application (e.g., any of FIGS. 1B-7), a RAN node, e.g., a base station (BS), may be distributed over a geographic region. In certain embodiments of the present application, the RAN node may also be referred to as an access point, an access terminal, a base, a base unit, a macro cell, a Node-B, an evolved Node B (eNB), a gNB, a Home Node-B, a relay node, or a device, or described using other terminology used in the art. The RAN node is generally a part of a radio access network that may include one or more controllers communicably coupled to one or more corresponding RAN nodes. In certain embodiments of the present application with a CU-DU architecture, the RAN node may include a CU and one or more DUs.

In some embodiments of the present application, a RAN node, e.g., a BS, may communicate using other communication protocols, such as the IEEE 902.11 family of wireless communication protocols. Further, in some embodiments of the present application, the RAN node may communicate over licensed spectrums, whereas in other embodiments, the RAN node may communicate over unlicensed spectrums. The present application is not intended to be limited to the implementation of any particular wireless communication system architecture or protocol. In yet some embodiments of present application, the RAN node may communicate with a UE using the 3GPP 5G protocols.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

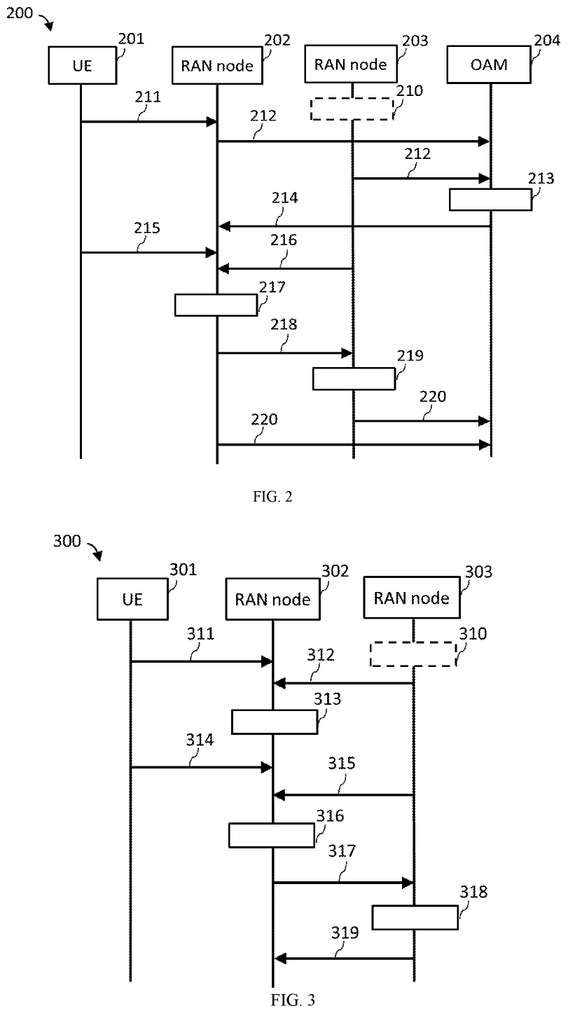

FIG. 1B illustrates an exemplary flow chart for performing an inference operation for CCO in accordance with some embodiments of the present application. The exemplary flow chart 200A may be performed by a network device (e.g., a RAN node or a CU). Specific examples of exemplary flow chart 200A are described in embodiments of FIGS. 2-7 as follows. Although described with respect to a network device, it should be understood that other devices may be configured to perform a method similar to that of FIG. 1B. Details described in all other embodiments of the present application (for example, all details regarding an AI/ML based CCO mechanism) are applicable for the exemplary flow chart 200A. Moreover, details described in the exemplary flow chart 200A are applicable for all the embodiments of FIGS. 1A-9.

In the exemplary flow chart 200A as shown in FIG. 1B, in operation 201A, a network device (e.g., RAN node 202, RAN node 302, CU 403, CU 503, CU 603, or CU 703 as shown in any of FIGS. 2-7) obtains inference input data (e.g., inference data as illustrated in FIG. 1A) associated with CCO. In operation 202A, the network device performs an inference operation of a processing model (e.g., AI model or ML model) for CCO based on the inference input data, e.g., the network device performs AI/ML based CCO. In operation 203A, the network device generates output data of the inference operation of the processing model for CCO (which is named as “the 1st output data of AI/ML based CCO” or “the 1st output data of the inference operation of the processing model for CCO” for simplicity), e.g., the network device generates output of AI/ML based CCO.

In some embodiments, the 1st output data of AI/ML based CCO includes at least one of:
(1) A set of CCO issue(s) predicted by the network device.
(2) A set of predicted cell(s) in which there is an issue within the set of predicted CCO issue(s). In an embodiment, the issue within the set of predicted CCO issue(s) is related to at least one of: coverage of a cell within the set of predicted cell(s), or a cell edge capacity of the cell within the set of predicted cell(s). In an embodiment, a cell within the set of predicted cell(s) is represented by at least one of: global cell identity (e.g., CGI), PCI, and carrier frequency (e.g., ARFCN).
(3) A set of predicted synchronization signal block(s) (SSBs) in which there is an issue within the set of predicted CCO issue(s). In an embodiment, a SSB within the set of predicted SSB(s) is represented by at least one of: SSB index, or SSB id.
(4) Predicted validity time for an issue within the set of predicted CCO issue(s). The predicted validity time for each issue in the set of predicted CCO issue(s) may be same or different.
(5) Predicted validity time for a cell within the set of predicted cell(s). The predicted validity time for each cell within the set of predicted cell(s) may be same or different.
(6) Predicted validity time for a SSB within the set of predicted SSB(s). The predicted validity time for each SSB within the set of predicted SSB(s) may be same or different. In an embodiment, the predicted validity time in any two of above points (4)-(6) in the 1st output data of AI/ML based CCO may be identical or different.

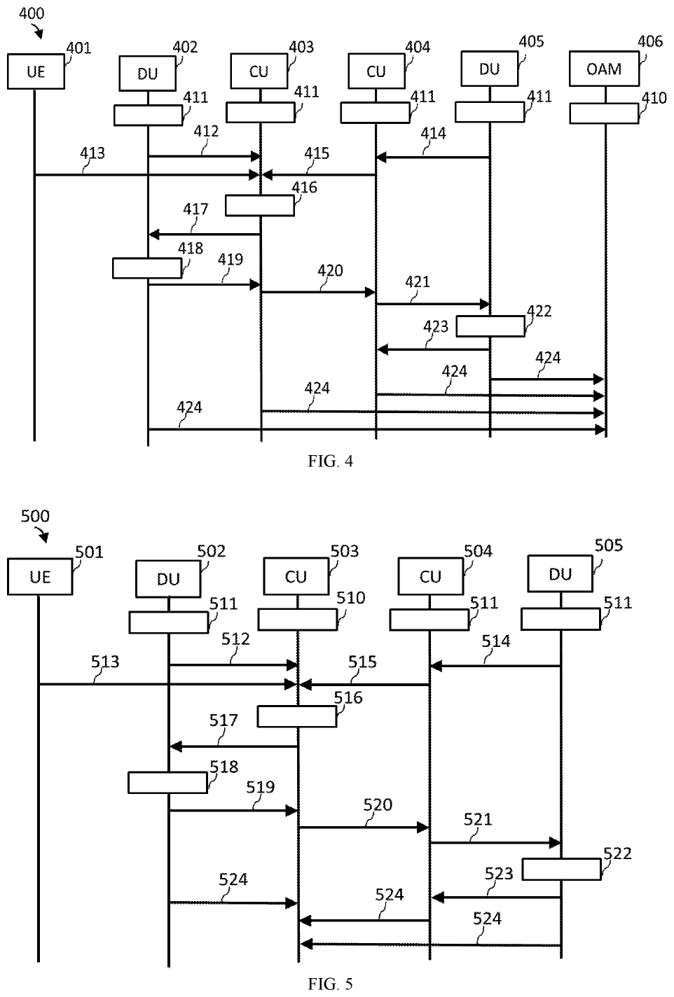

In some embodiments, the processor of the network device is configured to generate further output data of the inference operation of the processing model for CCO (which is named as “the 2nd output data of AI/ML based CCO” or “the 2nd output data of the inference operation of the processing model for CCO” for simplicity), e.g., the network device generates further output of AI/ML based CCO. In an embodiment, the network device is a CU (e.g., CU 403, CU 503, CU 603, or CU 703 as shown in any of FIGS. 4-7), and the processor of the CU is configured to transmit the 1st output data of AI/ML based CCO and/or the 2nd output data of AI/ML based CCO to at least one DU managed by the CU (e.g., DU 402, DU 502, DU 602, or DU 702 as shown in any of FIGS. 4-7). In an embodiment, the processor of the network device is configured to transmit the 1st output data of AI/ML based CCO and/or the 2nd output data of AI/ML based CCO to a neighbour network device or a neighbour CU (e.g., RAN node 203, RAN node 303, CU 404, CU 504, CU 604, or CU 704 as shown in any of FIGS. 2-7).

In some embodiments, the network device is a CU, and the processor of the CU is configured: to transmit the 1st output data of AI/ML based CCO to at least one DU managed by the CU; and to receive additional output data of AI/ML based CCO from the DU managed by the CU. The additional output data of AI/ML based CCO received from the DU is generated by the DU, e.g., the DU performs an inference operation of a processing model (e.g., AI model or ML model) for CCO, or the DU performs AI/ML based CCO. The additional output data of AI/ML based CCO received from the DU may include similar data to or same data as the further output data of AI/ML based CCO generated by the network device, and thus may also be named as “the 2nd output data of AI/ML based CCO”.

In some embodiments, the 2nd output data of AI/ML based CCO includes at least one of:
(1) A set of predicted cell coverage modification configuration(s). In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s)), it is used to solve the corresponding predicted CCO issue, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s). In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s)), it is used to solve the corresponding predicted CCO issue, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a configuration within the set of predicted cell coverage modification configuration(s). The predicted validity time for each configuration within the set of predicted cell coverage modification configuration(s) may be same or different.
(4) Predicted validity time for a configuration within the set of predicted SSB coverage modification configuration(s). The predicted validity time for each configuration within the set of predicted SSB coverage modification configuration(s) may be same or different. In an embodiment, the predicted validity time in above points (3) and (4) in the 2nd output data of AI/ML based CCO may be identical or different.

In some embodiments, the inference input data obtained by the network device in operation 201A is local inference input data. In some other embodiments, the inference input data obtained by the network device in operation 201A is received from: a UE, a neighbour network device, a neighbour CU, one or more DUs managed by the neighbour CU, and/or a DU managed by the network device when the network device is a CU.

In an embodiment, the inference input data received from the UE (e.g., UE 201, UE 301, UE 401, UE 501, UE 601, or UE 701 as shown in any of FIGS. 2-7) includes at least one of:
(1) location information of the UE, e.g., including coordinates, serving cell ID, and/or moving velocity;
(2) mobility history information of the UE;
(3) measurement result(s) from the UE, e.g., RSRP, RSRQ and/or SINR measurement, including cell level and/or beam level measurement results;
(4) a connection establishment failure (CEF) report from the UE;
(5) a radio access (RA) report from the UE; or
(6) a radio link failure (RLF) report from the UE.

In an embodiment, the inference input data received from the neighbour network device (e.g., RAN node 203 or RAN node 303 as shown in any of FIGS. 2 and 3), the neighbour CU (e.g., CU 404, CU 504, CU 604, or CU 704 as shown in any of FIGS. 4-7), and/or the DU managed by the neighbour CU (e.g., DU 402, DU 502, DU 602, or DU 702 as shown in any of FIGS. 4-7) includes at least one of:
(1) a current resource status or load information;
(2) a historical resource status or load information; or
(3) a predicted resource status or load information.

In an embodiment, the local inference input data obtained by the network device or the inference input data received from the DU managed by the network device includes at least one of:
(1) a historical resource status or load information;
(2) a current resource status or load information;
(3) a predicted resource status or load information;
(4) a trajectory prediction of the UE;
(5) historical traffic of the UE;
(6) current traffic of the UE; or
(7) predicted traffic of the UE.

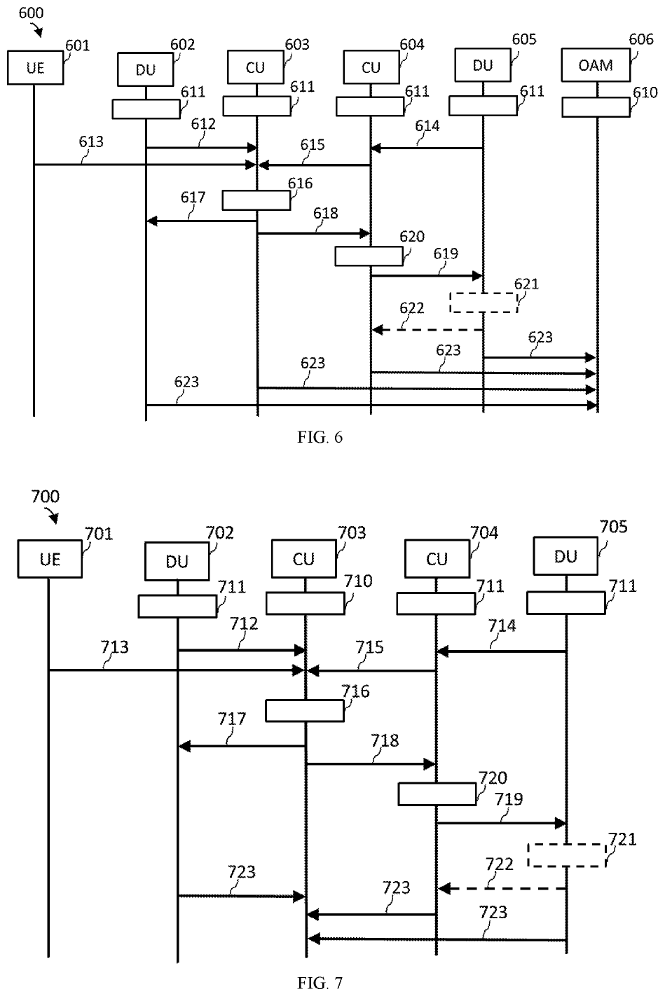

In some embodiments, the processor of the network device is configured to transmit processing model performance feedback information to an operation administration and maintenance (OAM) entity (e.g., OAM 406 or OAM 606 as shown in any of FIGS. 4 and 6). In some other embodiments, the processor of the network device is configured to receive the processing model performance feedback information from: a neighbour network device, a neighbour CU, one or more DU(s) managed by the neighbour CU, and/or one or more DU(s) managed by the network device when the network device is a CU.

In some embodiments, the processing model performance feedback information includes at least one of:
(1) a local resource status or load information;
(2) at least one local system key performance indicator (KPI), e.g., including throughput, delay or RLF in local CU/DU;
(3) a neighbouring resource status, e.g., a resource status of a neighbour cell; or
(4) at least one neighbouring system KPI, e.g., a system KPI of a neighbour cell, e.g., including throughput, delay or RLF in neighbour CU/DU.

In addition, some other embodiments of the present application provide an exemplary flowchart of receiving output data of AI/ML based CCO, which may be performed by a network device, for example, a BS (e.g., a neighbour RAN node or a neighbour CU of the network device in embodiments of FIG. 1B). Specific examples of this exemplary flowchart are described in embodiments of FIGS. 4-7 as follows.

Although described with respect to a network device, it should be understood that other devices may be configured to perform a similar method. Details described in all other embodiments of the present application, e.g., in the embodiments of FIGS. 2-7 (for example, all details regarding an AI/ML based CCO mechanism) are applicable for this exemplary flowchart. Moreover, details described in this exemplary flowchart are applicable for all the embodiments of FIGS. 1A-9.

In particular, in this exemplary flowchart, a network device (e.g., RAN node 203, RAN node 303, CU 404, CU 504, CU 604, or CU 704 as shown in any of FIGS. 2-7) receives output data of an inference operation of a processing model for CCO from a neighbour network device or a neighbour CU (e.g., RAN node 202, RAN node 302, CU 403, CU 503, CU 603, or CU 703 as shown in any of FIGS. 2-7). For instance, the network device receives 1st output data of AI/ML based CCO and/or 2nd output data of AI/ML based CCO. The 1st output data of AI/ML based CCO is associated with an inference operation of a processing model of the neighbour network device or the neighbour CU, e.g., the neighbour network device or the neighbour CU has the AI/ML model for CCO inference, and the 1st output data of AI/ML based CCO is generated by the neighbour network device or the neighbour CU. The 2nd output data of AI/ML based CCO may be associated with the inference operation of the processing model of the neighbour network device or the neighbour CU, or may be associated with an inference operation of a processing model of at least one DU managed by the neighbour CU (e.g., DU 402 DU 502, DU 602, or DU 702 as shown in any of FIGS. 4-7), e.g., the neighbour network device, the neighbour CU or a DU managed by the neighbour CU has the AI/ML model for CCO inference, and the 2nd output data of AI/ML based CCO is generated by the neighbour network device, the neighbour CU or at least one DU managed by the neighbour CU.

In some embodiments, the 1st output data of AI/ML based CCO includes at least one of:
(1) A set of CCO issue(s) predicted by the neighbour network device or the neighbour CU.
(2) A set of predicted cell(s) in which there is an issue within the set of predicted CCO issue(s). In an embodiment, the issue within the set of predicted CCO issue(s) is related to: coverage of a cell within the set of predicted cells; and/or a cell edge capacity of the cell within the set of predicted cell(s). In an embodiment, a cell within the set of predicted cell(s) is represented by at least one of: global cell identity (e.g., CGI), PCI, and carrier frequency (e.g., ARFCN).
(3) A set of predicted SSB(s) in which there is an issue within the set of predicted CCO issue(s). In an embodiment, a SSB within the set of predicted SSB(s) is represented by at least one of: SSB index, or SSB id.
(4) Predicted validity time for an issue within the set of predicted CCO issue(s). The predicted validity time for each issue in the set of predicted CCO issue(s) may be same or different.
(5) Predicted validity time for a cell within the set of predicted cell(s). The predicted validity time for each cell within the set of predicted cell(s) may be same or different.
(6) Predicted validity time for a SSB within the set of predicted SSB(s). The predicted validity time for each SSB within the set of predicted SSB(s) may be same or different. In some embodiments, the predicted validity time in any two of above points (4)-(6) in the 1st output data of AI/ML based CCO may be identical or different.

In some embodiments, the 2nd output data of AI/ML based CCO includes at least one of:
(1) A set of predicted cell coverage modification configuration(s). In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s)), it is used to solve the corresponding predicted CCO issue, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s). In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s)), it is used to solve the corresponding predicted CCO issue, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a configuration within the set of predicted cell coverage modification configuration(s). The predicted validity time for each configuration within the set of predicted cell coverage modification configuration(s) may be same or different.
(4) Predicted validity time for a configuration within the set of predicted SSB coverage modification configuration(s). The predicted validity time for each configuration within the set of predicted SSB coverage modification configuration(s) may be same or different. In an embodiment, the predicted validity time in above points (3) and (4) in the 2nd output data of AI/ML based CCO may be identical or different.

In some embodiments, the network device is a CU (e.g., CU 404, CU 504, CU 604, or CU 704 as shown in any of FIGS. 4-7), and the processor of the CU is configured to transmit the 1st output data of AI/ML based CCO and/or the 2nd output data of AI/ML based CCO to a DU managed by the CU (e.g., DU 405, DU 505, DU 605, or DU 705 as shown in any of FIGS. 4-7).

In some embodiments, the processor of the network device is configured: to perform an inference operation of a processing model for CCO; and to generate further output data of the inference operation of the processing model for CCO, for example, 3rd output data of AI/ML based CCO (or named as “the 3rd output data of the inference operation of the processing model for CCO”) and/or 4th output data of AI/ML based CCO (or named as “the 4th output data of the inference operation of the processing model for CCO”). In an embodiment, the network device is a CU (e.g., CU 404, CU 504, CU 604, or CU 704 as shown in any of FIGS. 4-7), and the processor of the CU is configured to transmit the 3rd output data of AI/ML based CCO and/or the 4th output data of AI/ML based CCO to at least one DU managed by the CU (e.g., DU 405, DU 505, DU 605, or DU 705 as shown in any of FIGS. 4-7).

In some embodiments, the 3rd output data of AI/ML based CCO is associated with an inference operation of a processing model of the network device or the CU, e.g., the network device or the CU has the AI/ML model for CCO inference, or, the network device or the CU performs AI/ML based CCO. The 3rd output data of AI/ML based CCO is predicted or generated by the network device or the CU, after the network device or the CU receives the 1st and/or 2nd output data of AI/ML based CCO. The 3rd output data of AI/ML based CCO includes at least one of:
(1) A set of CCO issue(s) predicted by the network device or the CU.
(2) A set of predicted cell(s) in which there is an issue within the set of predicted CCO issue(s). The predicted cell(s) is managed by the network device or the CU. In an embodiment, the issue within the set of predicted CCO issue(s) is related to at least one of: coverage of a cell within the set of predicted cell(s), or a cell edge capacity of the cell within the set of predicted cell(s). In an embodiment, a cell within the set of predicted cell(s) is represented by at least one of: global cell identity (e.g., CGI), PCI, and carrier frequency (e.g., ARFCN).
(3) A set of predicted SSB(s) in which there is an issue within the set of predicted CCO issue(s). The predicted SSB(s) is managed by the network device or the CU. In an embodiment, a SSB within the set of predicted SSB(s) is represented by at least one of: SSB index, or SSB id.
(4) Predicted validity time for an issue within the set of predicted CCO issue(s). The predicted validity time for each issue in the set of predicted CCO issue(s) may be same or different.
(5) Predicted validity time for a cell within the set of predicted cell(s). The predicted validity time for each cell within the set of predicted cell(s) may be same or different.
(6) Predicted validity time for a SSB within the set of predicted SSB(s). The predicted validity time for each SSB within the set of predicted SSB(s) may be same or different. In an embodiment, the predicted validity time in any two of above points (4)-(6) in the 3rd output data of AI/ML based CCO may be identical or different.

In some embodiments, the 4th output data of AI/ML based CCO is associated with an inference operation of a processing model of the network device or the CU, e.g., the network device or the CU has the AI/ML model for CCO inference, or, the network device or the CU performs AI/ML based CCO. The 4th output data of AI/ML based CCO is generated by the network device or the CU, after the network device or the CU receives the 1st and/or 2nd output data of AI/ML based CCO. The 4th output data of AI/ML based CCO includes at least one of:
(1) A set of predicted cell coverage modification configuration(s). In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s)), it is used to solve the corresponding predicted CCO issue, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s). In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s)), it is used to solve the corresponding predicted CCO issue, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a configuration within the set of predicted cell coverage modification configuration(s). The predicted validity time for each configuration within the set of predicted cell coverage modification configuration(s) may be same or different.
(4) Predicted validity time for a configuration within the set of predicted SSB coverage modification configuration(s). The predicted validity time for each configuration within the set of predicted SSB coverage modification configuration(s) may be same or different. In an embodiment, the predicted validity time in above points (3) and (4) in the 4th output data of AI/ML based CCO may be identical or different.

In some embodiments, the network device is a CU (e.g., CU 404, CU 504, CU 604, or CU 704 as shown in any of FIGS. 4-7), and the processor of the CU is configured to receive additional output data of AI/ML based CCO (e.g., 5th output data of AI/ML based CCO, or “the 5th output data of the inference operation of the processing model for CCO”) from at least one DU managed by the CU (e.g., DU 405, DU 505, DU 605, or DU 705 as shown in any of FIGS. 4-7).

In some embodiments, the 5th output data of AI/ML based CCO is generated by the DU, e.g., the DU performs an inference operation of a processing model (e.g., AI model or ML model) for CCO, or the DU performs AI/ML based CCO. The 5th output data of AI/ML based CCO is associated with at least one of: the 1st output data of AI/ML based CCO, the 2nd output data of AI/ML based CCO, the 3th output data of AI/ML based CCO, or the 4th output data of AI/ML based CCO. For example, the 5th output data of AI/ML based CCO is used to solve the predicted issue within the 1st and/or 3rd output data of AI/ML based CCO, or, the 5th output data of AI/ML based CCO is used to fit to the predicted coverage modification configuration(s) within the 2nd and/or 4th output data of AI/ML based CCO. The 5th output data of AI/ML based CCO is generated by the DU, after the DU receives at least one of: the 1st output data of AI/ML based CCO, the 2nd output data of AI/ML based CCO, the 3th output data of AI/ML based CCO, or the 4th output data of AI/ML based CCO, from its CU. The 5th output data of AI/ML based CCO includes at least one of:
(1) A set of predicted cell coverage modification configuration(s) predicted by the DU managed by the CU. In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s)), it is used to solve the corresponding predicted CCO issue, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s) predicted by the DU managed by the CU. In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s)), it is used to solve the corresponding predicted CCO issue, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a configuration within the set of predicted cell coverage modification configuration(s) predicted by the DU managed by the CU. The predicted validity time for each configuration within the set of predicted cell coverage modification configuration(s) may be same or different.
(4) Predicted validity time for a configuration within the set of predicted SSB coverage modification configuration(s) predicted by the DU managed by the CU. The predicted validity time for each configuration within the set of predicted SSB coverage modification configuration(s) may be same or different. In an embodiment, the predicted validity time in above points (3) and (4) in the 5th output data of AI/ML based CCO may be identical or different.

In some embodiments, a configuration within any set of predicted cell coverage modification configuration(s) in the 2nd, 4th, and/or 5th output data of AI/ML based CCO may include at least one of:
(1) A predicted cell coverage state. In some embodiments, the predicted cell coverage state is used to indicate the predicted cell coverage configuration for modification to solve the predicted CCO issue related with the corresponding predicted cell.
(2) A predicted cell deployment status indicator. In some embodiments, the predicted cell deployment status indicator is used to indicate whether the predicted cell needs to be modified at next planned configuration.
(3) Predicted cell replacing information. In some embodiments, if the predicted cell deployment status indicator is used to indicate the predicted cell needs to be modified at next planned configuration, the predicted cell replacing information is used to indicate the predicted one or more replacing cells that may replace part or all of the coverage of the predicted cell.

In some embodiments, a configuration within any set of predicted SSB coverage modification configuration(s) in the 2nd, 4th, and/or 5th output data of AI/ML based CCO may include at least one of:
(1) A predicted SSB coverage state. In some embodiments, the predicted SSB coverage state is used to indicate the predicted SSB coverage configuration for modification to solve the predicted CCO issue related with the corresponding predicted SSB.
(2) A predicted SSB deployment status indicator. In some embodiments, the predicted SSB deployment status indicator is used to indicate whether the predicted SSB needs to be modified at next planned configuration.
(3) Predicted SSB replacing information. In some embodiments, if the predicted SSB deployment status indicator is used to indicate the predicted SSB needs to be modified at next planned configuration, the predicted SSB replacing information is used to indicate the predicted one or more replacing SSBs that may replace part or all of the coverage of the predicted SSB.

In some embodiments, the processor of the network device is configured to generate inference input data associated with CCO and to transmit the inference input data to the neighbour network device or the neighbour CU. In some other embodiments, the network device is a CU, and after receiving inference input data associated with CCO from a DU managed by the CU, the CU transmits the inference input data to the neighbour network device or the neighbour CU. In an embodiment, the inference input data generated by network device or received from the DU includes: a current resource status; a historical resource status; and/or a predicted resource status.

In some embodiments, the processor of the network device is configured to transmit processing model performance feedback information to an OAM entity (e.g., OAM 406 or OAM 606 as shown in any of FIGS. 4 and 6), the neighbour network device (e.g., RAN node 202 or RAN node 302 in any of FIGS. 2 and 3), or the neighbour CU (e.g., CU 403, CU 503, CU 603, or CU 703 as shown in any of FIGS. 4-7). In an embodiment, the processing model performance feedback information includes: a local resource status; at least one local system KPI; a neighbouring resource status; and/or at least one neighbouring system KPI.

Furthermore, some other embodiments of the present application provide an exemplary flowchart of receiving output data of AI/ML based CCO, which may be performed by a DU (e.g., DU 402, DU 502, DU 602, or DU 702 as shown in any of FIGS. 4-7). Specific examples of this exemplary flowchart are described in embodiments of FIGS. 4-7 as follows.

Although described with respect to a DU, it should be understood that other devices may be configured to perform a similar method. Details described in all other embodiments of the present application (for example, all details regarding an AI/ML based CCO mechanism) are applicable for this exemplary flowchart. Moreover, details described in this exemplary flowchart are applicable for all the embodiments of FIGS. 1A-9.

In particular, in the abovementioned exemplary flowchart, a DU (e.g., DU 402, DU 502, DU 602, or DU 702 as shown in any of FIGS. 4-7) receives output data of AI/ML based CCO from a CU (e.g., CU 403, CU 503, CU 603, or CU 703 as shown in any of FIGS. 4-7). The DU is managed by the CU. The output data of AI/ML based CCO is associated with an inference operation of a processing model of the CU, e.g., the CU performs AI/ML based CCO, and generates the 1st and/or 2nd output of AI/ML based CCO. For example, the DU receives 1st output data of AI/ML based CCO or “the 1st output data of the inference operation of the processing model for CCO”.

In some embodiments, the 1st output data of AI/ML based CCO includes at least one of:
(1) A set of CCO issue(s) predicted by the CU.
(2) A set of predicted cell(s) in which there is an issue within the set of predicted CCO issue(s). In an embodiment, an issue within the set of predicted CCO issue(s) is related to: coverage of a cell within the set of predicted cell(s), and/or a cell edge capacity of the cell within the set of predicted cell(s). In an embodiment, a cell within the set of predicted cell(s) is represented by at least one of: global cell identity (e.g., CGI), PCI, and carrier frequency (e.g., ARFCN).
(3) A set of predicted SSB(s) in which there is an issue within the set of predicted CCO issue(s). In an embodiment, a SSB within the set of predicted SSB(s) is represented by at least one of: SSB index, or SSB id.
(4) Predicted validity time for an issue within the set of predicted CCO issue(s). The predicted validity time for each issue in the set of predicted CCO issue(s) may be same or different.
(5) Predicted validity time for a cell within the set of predicted cell(s). The predicted validity time for each cell within the set of predicted cell(s) may be same or different.
(6) Predicted validity time for a SSB within the set of predicted SSB(s). The predicted validity time for each SSB within the set of predicted SSB(s) may be same or different. In an embodiment, the predicted validity time in any two of above points (4)-(6) in the 1st output data of AI/ML based CCO may be identical or different.

In some embodiments, besides 1st output data of AI/ML based CCO, the processor of the DU is configured to receive further output data of AI/ML based CCO from the CU (e.g., CU 403, CU 503, CU 603, or CU 703 as shown in any of FIGS. 4-7), e.g., 2nd output data of AI/ML based CCO. The 2nd output data of AI/ML based CCO may include at least one of:
(1) A set of predicted cell coverage modification configuration(s). In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s)), it is used to solve the corresponding predicted CCO issue, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s). In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s)), it is used to solve the corresponding predicted CCO issue, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a cell within the set of predicted cell coverage modification configuration(s). The predicted validity time for each configuration within the set of predicted cell coverage modification configuration(s) may be same or different.
(4) Predicted validity time for a SSB within the set of predicted SSB coverage modification configuration(s). The predicted validity time for each configuration within the set of predicted SSB coverage modification configuration(s) may be same or different. In an embodiment, the predicted validity time in above points (3) and (4) in the 2nd output data of AI/ML based CCO may be identical or different.

In some embodiments, the processor of the DU is configured: to perform an inference operation of a processing model for CCO; and to generate additional output data of AI/ML based CCO, e.g., 3rd output data of AI/ML based CCO. The 3rd output data of AI/ML based CCO is associated with an inference operation of a processing model of the DU, e.g., the DU has the AI/ML model for CCO inference, or, the DU performs AI/ML based CCO. The 3rd output data of AI/ML based CCO is generated by the DU, after the DU receives the 1st and/or 2nd output data of AI/ML based CCO from its CU. The 3rd output data of AI/ML based CCO is used to solve the predicted issue within the 1st output data of AI/ML based CCO. Or, the 3rd output data of AI/ML based CCO is used to fit to the predicted coverage modification configuration(s) within the 2nd output data of AI/ML based CCO. In an embodiment, the processor of the DU is configured to transmit the 3rd output data of AI/ML based CCO to the CU (e.g., CU 403, CU 503, CU 603, or CU 703 as shown in any of FIGS. 4-7). In an embodiment, the 3rd output data of AI/ML based CCO includes at least one of:
(1) A set of predicted cell coverage modification configuration(s) predicted by the DU. In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s)), it is used to solve the corresponding predicted CCO issue, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s) predicted by the DU. In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s)), it is used to solve the corresponding predicted CCO issue, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a cell within the set of predicted cell coverage modification configuration(s). The predicted validity time for each configuration within the set of predicted cell coverage modification configuration(s) may be same or different.
(4) Predicted validity time for a SSB within the set of predicted SSB coverage modification configuration(s). The predicted validity time for each configuration within the set of predicted SSB coverage modification configuration(s) may be same or different. In some embodiments, the predicted validity time in above points (3) and (4) in the 3rd output data of AI/ML based CCO may be identical or different.

In some embodiments, a configuration within any set of predicted cell coverage modification configuration(s) in the 2nd and/or 3rd output data of AI/ML based CCO includes at least one of:
(1) A predicted cell coverage state. In some embodiments, the predicted cell coverage state is used to indicate the predicted cell coverage configuration for modification to solve the predicted CCO issue related with the corresponding predicted cell.
(2) A predicted cell deployment status indicator. In some embodiments, the predicted cell deployment status indicator is used to indicate whether the predicted cell needs to be modified at next planned configuration.
(3) Predicted cell replacing information. In some embodiments, if the predicted cell deployment status indicator is used to indicate the predicted cell needs to be modified at next planned configuration, the predicted cell replacing information is used to indicate the predicted one or more replacing cells that may replace part or all of the coverage of the predicted cell.

In some embodiments, a configuration within any set of predicted SSB coverage modification configuration(s) in the 2nd and/or 3rd output data of AI/ML based CCO includes at least one of:
(1) A predicted SSB coverage state. In some embodiments, the predicted SSB coverage state is used to indicate the predicted SSB coverage configuration for modification to solve the predicted CCO issue related with the corresponding predicted SSB.
(2) A predicted SSB deployment status indicator. In some embodiments, the predicted SSB deployment status indicator is used to indicate whether the predicted SSB needs to be modified at next planned configuration.
(3) Predicted SSB replacing information. In some embodiments, if the predicted SSB deployment status indicator is used to indicate the predicted SSB needs to be modified at next planned configuration, the predicted SSB replacing information is used to indicate the predicted one or more replacing SSBs that may replace part or all of the coverage of the predicted SSB.

In some embodiments, the processor of the DU is configured to transmit processing model performance feedback information to an OAM entity (e.g., OAM 406 or OAM 606 as shown in any of FIGS. 4 and 6) or the CU (e.g., CU 403, CU 503, CU 603, or CU 703 as shown in any of FIGS. 4-7). In an embodiment, the processing model performance feedback information includes: a local resource status; at least one local system KPI; a neighbouring resource status; and/or at least one neighbouring system KPI.

Some additional embodiments of the present application provide an exemplary flowchart of receiving output data of AI/ML based CCO by a DU managed by a CU from the CU. For example, the DU (e.g., DU 405, DU 505, DU 605, or DU 705 as shown in any of FIGS. 4-7) may be deemed as a neighbour DU managed by a neighbour CU in view of the network device in the embodiments of FIG. 1B. Specific examples of this exemplary flowchart are described in embodiments of FIGS. 4-7 as follows.

Although described with respect to a DU, it should be understood that other devices may be configured to perform a similar method. Details described in all other embodiments of the present application (for example, all details regarding an AI/ML based CCO mechanism) are applicable for this exemplary flowchart. Moreover, details described in this exemplary flowchart are applicable for all the embodiments of FIGS. 1A-9.

In particular, in the abovementioned exemplary flowchart, a DU (e.g., DU 405, DU 505, DU 605, or DU 705 as shown in any of FIGS. 4-7) receives output data of AI/ML based CCO from a CU (e.g., CU 404, CU 504, CU 604, or CU 704 as shown in any of FIGS. 4-7), e.g., the 1st and/or 2nd output data of AI/ML based CCO. The DU is managed by the CU. The 1st output data of AI/ML based CCO is associated with an inference operation of a processing model of a neighbour network device or a neighbour CU (e.g., CU 403, CU 503, CU 603, or CU 703 as shown in any of FIGS. 4-7), e.g., the 1st output data of AI/ML based CCO is predicted or generated by the neighbour network device or the neighbour CU. The 2nd output data of AI/ML based CCO is associated with the inference operation of the processing model of the neighbour network device or the neighbour CU, or associated with an inference operation of a processing model of at least one DU managed by the neighbour CU (e.g., DU 402, DU 502, DU 602, or DU 702 as shown in any of FIGS. 4-7), e.g., the 2nd output data of AI/ML based CCO is predicted or generated by the neighbour network device or the neighbour CU or the DU managed by the neighbour CU.

In some embodiments, the 1st output data of AI/ML based CCO includes at least one of:
(1) A set of CCO issue(s) predicted by the neighbour network device or the neighbour CU.
(2) A set of predicted cell(s) in which there is an issue within the set of predicted CCO issue(s). The set of predicted cell(s) is predicted by the neighbour network device or the neighbour CU. In an embodiment, the issue within the set of predicted CCO issue(s) is related to: coverage of a cell within the set of predicted cell(s); and/or a cell edge capacity of the cell within the set of predicted cell(s). In an embodiment, a cell within the set of predicted cell(s) is represented by at least one of: global cell identity (e.g., CGI), PCI, or and carrier frequency (e.g., ARFCN).
(3) A set of predicted SSB(s) in which there is an issue within the set of predicted CCO issue(s). The set of predicted SSB(s) is predicted by the neighbour network device or the neighbour CU. In an embodiment, a SSB within the set of predicted SSB(s) is represented by at least one of: SSB index, or SSB id.
(4) Predicted validity time for an issue within the set of predicted CCO issue(s). The predicted validity time for each issue in the set of predicted CCO issue(s) may be same or different.
(5) Predicted validity time for a cell within the set of predicted cell(s). The predicted validity time for each cell within the set of predicted cell(s) may be same or different.
(6) Predicted validity time for a SSB within the set of predicted SSB(s). The predicted validity time for each SSB within the set of predicted SSB(s) may be same or different. In an embodiment, the predicted validity time in any two of above points (4)-(6) in the 1st output data of CCO may be identical or different.

In some embodiments, the 2nd output data of AI/ML based CCO includes at least one of:
(1) A set of predicted cell coverage modification configuration(s). In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s) as mentioned in 1st output data of AI/ML based CCO), it is used to solve the corresponding predicted CCO issue, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s). In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s) as mentioned in 1st output data of AI/ML based CCO), it is used to solve the corresponding predicted CCO issue, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a cell within the set of predicted cell coverage modification configuration(s). The predicted validity time for each configuration within the set of predicted cell coverage modification configuration(s) may be same or different.
(4) Predicted validity time for a SSB within the set of predicted SSB coverage modification configuration(s). The predicted validity time for each configuration within the set of predicted SSB coverage modification configuration(s) may be same or different. In an embodiment, the predicted validity time in above points (3) and (4) in the 2nd output data of CCO may be identical or different.

In some embodiments, the processor of the DU is configured to receive additional output data of CCO, e.g., 3rd output data of AI/ML CCO and/or 4th output data of AI/ML CCO, from the CU. The 3rd output data of AI/ML based CCO and/or the 4th output data of AI/ML CCO are associated with an inference operation of a processing model of the CU, e.g., the CU has the AI/ML model for CCO inference, or, the CU performs AI/ML based CCO. The 3rd output data of AI/ML based CCO and/or the 4th output data of AI/ML CCO are predicted or generated by the CU, after the CU receives the 1st and/or 2nd output data of AI/ML based CCO from the neighbour CU. The 3rd output data of AI/ML based CCO may include at least one of:
(1) A set of CCO issue(s) predicted by the CU;
(2) A set of predicted cell(s) in which there is an issue within the set of predicted CCO issue(s). The predicted cell is managed by the CU. In an embodiment, the issue within the set of predicted CCO issue(s) is related to at least one of: coverage of a cell within the set of predicted cell(s), or a cell edge capacity of the cell within the set of predicted cell(s). In an embodiment, a cell within the set of predicted cell(s) is represented by at least one of: global cell identity (e.g., CGI), PCI, or and carrier frequency (e.g., ARFCN).
(3) A set of predicted SSBs in which there is an issue within the set of predicted CCO issue(s). The predicted SSB is managed by the CU. In an embodiment, a SSB within the set of predicted SSB(s) is represented by at least one of: SSB index, or SSB id.
(4) Predicted validity time for an issue within the set of predicted CCO issue(s). The predicted validity time for each issue in the set of predicted CCO issue(s) may be same or different.
(5) Predicted validity time for a cell within the set of predicted cell(s). The predicted validity time for each cell within the set of predicted cell(s) may be same or different.
(6) Predicted validity time for a SSB within the set of predicted SSB(s). The predicted validity time for each SSB within the set of predicted SSB(s) may be same or different. In an embodiment, the predicted validity time in any two of above points (4)-(6) in the 3rd output data of AI/ML based CCO may be identical or different.

The 4th output data of AI/ML based CCO may include at least one of:
(1) A set of predicted cell coverage modification configuration(s) predicted by the CU. In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s) as mentioned in 3rd output data of AI/ML based CCO), it is used to solve the corresponding predicted CCO issue as mentioned in 3rd output data of AI/ML based CCO, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s) predicted by the CU. In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s) as mentioned in 3rd output data of AI/ML based CCO), it is used to solve the corresponding predicted CCO issue as mentioned in 3rd output data of AI/ML based CCO, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a configuration within the set of predicted cell coverage modification configuration(s). The predicted validity time for each configuration within the set of predicted cell coverage modification configuration(s) may be same or different.
(4) Predicted validity time for a configuration within the set of predicted SSB coverage modification configuration(s). The predicted validity time for each configuration within the set of predicted SSB coverage modification configuration(s) may be same or different. In an embodiment, the predicted validity time in above points (3) and (4) in the 4th output data of AI/ML based CCO may be identical or different.

In some embodiments, the processor of the DU is configured: to perform an inference operation of a processing model for CCO; and to generate output data of CCO, e.g., 5th output data of AI/ML based CCO. The 5th output data of AI/ML based CCO is associated with an inference operation of a processing model of the DU. In an embodiment, the processor of the DU is configured to transmit the 5th output data of AI/ML based CCO to the CU. In an embodiment, the 5th output data of AI/ML based CCO includes at least one of:
(1) A set of predicted cell coverage modification configuration(s) predicted by the DU. In an embodiment, a configuration within this set includes at least one of: a predicted cell coverage state; a predicted cell deployment status indicator; predicted cell replacing information. For example, a configuration within this set corresponds to a cell (e.g., a cell within the set of predicted cell(s) in which there is an issue within the set of predicted CCO issue(s) as mentioned in 1st and/or 3rd output data of AI/ML based CCO), it is used to solve the corresponding predicted CCO issue as mentioned in 1st and/or 3rd output data of AI/ML based CCO, or to fit to actual/predicted neighbouring coverage modification configuration(s). For the cell within the set of predicted cell(s), the configuration within this set includes a predicted cell coverage state for the cell; a predicted cell deployment status indicator for the cell; and/or predicted cell replacing information for the cell.
(2) A set of predicted SSB coverage modification configuration(s) predicted by the DU. In an embodiment, a configuration within this set includes at least one of: a predicted SSB coverage state; a predicted SSB deployment status indicator; predicted SSB replacing information. For example, a configuration within this set corresponds to a SSB (e.g., a SSB within the set of predicted SSB(s) in which there is an issue within the set of predicted CCO issue(s) as mentioned in 1st and/or 3rd output data of AI/ML based CCO), it is used to solve the corresponding predicted CCO issue as mentioned in 1st and/or 3rd output data of AI/ML based CCO, or to fit to actual/predicted neighbouring coverage modification configuration(s). For the SSB within the set of predicted SSB(s), the configuration within this set includes a predicted SSB coverage state for the SSB; a predicted SSB deployment status indicator for the SSB; and/or predicted SSB replacing information for the SSB.
(3) Predicted validity time for a configuration within the set of predicted cell coverage modification configuration(s). The predicted validity time for each configuration within the set of predicted cell coverage modification configuration(s) may be same or different.
(4) Predicted validity time for a configuration within the set of predicted SSB coverage modification configuration(s). The predicted validity time for each configuration within the set of predicted SSB coverage modification configuration(s) may be same or different. In an embodiment, the predicted validity time in above points (3) and (4) in the 5th output data of AI/ML based CCO may be identical or different.

In some embodiments, a configuration within any set of predicted cell coverage modification configuration(s) in the 2nd, 4th, and/or 5th output data of CCO includes:
(1) a predicted cell coverage state;
(2) a predicted cell deployment status indicator; and/or
(3) predicted cell replacing information.

In some embodiments, a configuration within any set of predicted SSB coverage modification configuration(s) in the 2nd, 4th, and/or 5th output data of CCO includes:
(1) a predicted SSB coverage state;
(2) a predicted SSB deployment status indicator; and/or
(3) predicted SSB replacing information.

In some embodiments, the processor of the DU is configured to transmit processing model performance feedback information to an OAM entity (e.g., OAM 406 or OAM 606 as shown in any of FIGS. 4 and 6), the neighbour network device, or the neighbour CU (e.g., CU 403, CU 503, CU 603, or CU 703 as shown in any of FIGS. 4-7). In an embodiment, the processing model performance feedback information includes: a local resource status; at least one local system KPI; a neighbouring resource status; and/or at least one neighbouring system KPI.

FIG. 2 illustrates a flow chart of an exemplary procedure of wireless communications in accordance with some embodiments of the present application. The exemplary procedure 200 refers to a procedure in which AI/ML model training for CCO is performed in an OAM entity, while AI/ML model inference for CCO is performed in a RAN node.

Details described in all other embodiments of the present application are applicable for the embodiments shown in FIG. 2. It should be appreciated by persons skilled in the art that the sequence of the operations in exemplary procedure 200 in FIG. 2 may be changed and some of the operations in exemplary procedure 200 in FIG. 2 may be eliminated or modified, without departing from the spirit and scope of the disclosure.

In the exemplary procedure 200, RAN node 202 or RAN node 203 may be a NG-RAN node. In particular, following steps are performed in the exemplary procedure 200.
(1) Step 210 (optional): RAN node 203 (which may be a CU) is assumed to have an AI/ML model optionally, which can provide useful input information to RAN node 202 (which may be another CU), such as a predicted resource status and etc.
(2) Step 211: UE 201 reports to RAN node 202 measurement result(s) and/or location information (e.g., UE 201's measurement result(s) related to RSRP, RSRQ, SINR of a serving cell and neighbouring cells, velocity, position) and/or a CEF/RA/RLF report.
   (a) For instance, before UE 201 reports this information in Step 211, UE 201 may receive a configuration (e.g., RRM measurement configuration, MDT measurement configuration) from RAN node 202, which requests UE 201 to provide measurement result(s) and/or location information. Based on such network request, UE 201 may perform corresponding measurements.
(3) Step 212: RAN node 202 further sends UE 201's measurement result(s) together with other input data for Model Training to OAM 204. RAN node 203 also sends input data for Model Training to OAM 204. For instance, the input data for Model Training can include at least one of:
   (a) a current resource status;
   (b) a historical resource status;
   (c) a predicted resource status; or
   (d) mobility history information.
(4) Step 213: AI/ML Model Training is performed at OAM 204. The measurement result(s) from UE 201 and the input data from RAN node 202 and RAN node 203 are leveraged to train the AI/ML model.
(5) Step 214: OAM 204 deploys or updates an AI/ML model into RAN node 202. RAN node 202 is allowed to continue model training based on the received AI/ML model from OAM 204
(6) Step 215: UE 201 provides input data for Model Inference (inference input data) to RAN node 202.
   (a) For instance, before Step 215, UE 201 may receive a request from RAN node 202 that requests UE 201 to provide input data for inference. Based on the network request, UE 201 may collect and report the requested inference input data to RAN node 202.
   (b) For example, the input data for AI/ML based CCO from UE 201 can include at least one of:
      a) location information of UE 201 (e.g., coordinates, serving cell ID, and/or moving velocity);
      b) mobility history information of UE 201;
      c) measurement result(s) of UE 201 (e.g., RSRP, RSRQ, SINR measurement, etc.), including cell level and/or beam level measurement result(s);
      d) a CEF report of UE 201;
      e) an RA report of UE 201; or
      f) an RLF report of UE 201.
(7) Step 216: RAN node 202 receives input data for Model Inference from neighbouring RAN node 203.
   (a) For instance, before Step 216, RAN node 203 may receive a request from RAN node 202 that requests RAN node 203 to provide input data for inference. Based on this request, RAN node 203 may collect and report the requested inference input data to RAN node 202.
   (b) For example, the inference input data for AI/ML based CCO from neighbouring RAN node 203 can include at least one of:
      a) a current resource status;
      b) a historical resource status;
      c) current load information;
      d) historical load information; or
      e) a predicted resource status.
(8) Step 217: RAN node 202 performs model inference, based on the inference input data from UE 201, the inference input data from RAN node 203, and its local inference input data.
   (a) For example, the local inference input data for AI/ML based CCO can include at least one of:
      a) A historical resource status.
      b) A current resource status.
      c) A predicted resource status.
      d) A trajectory prediction of a UE, e.g., UE 201.
      e) Historical traffic of a UE, e.g., UE 201.
      f) Current traffic of a UE, e.g., UE 201.
      g) Predicted traffic of a UE, e.g., UE 201.
      h) Predicted resource status information of neighbor NG-RAN node(s), e.g., RAN node 203.
   (b) In step 217, RAN node 202 can perform AI/ML based CCO, e.g., predict CCO issue(s) (e.g., coverage or cell edge capacity) together with validity time, predict a set of cell(s) and/or a set of SSB index(es) affected by the predicted CCO issue(s), and predict the corresponding coverage modification configuration(s) to modify the affected cell(s) or SSB(s). The output data of AI/ML based CCO in RAN node 202 can include at least one of:
      a) One or more predicted CCO issue(s) (e.g., coverage or cell edge capacity) in RAN node 202.
      b) One or more predicted cell(s), i.e., CGI(s), PCI(s) and/or ARFCN(s) of affected cell(s) in which there is the predicted CCO issue(s) in RAN node 202.
      c) One or more predicted cell coverage modification configuration(s) in RAN node 202. For example, each affected cell has corresponding predicted cell coverage modification configuration(s). The predicted cell coverage modification configuration(s) is used to solve the predicted CCO issue(s), and may include at least one of:
         1) A predicted cell coverage state. In some embodiments, the predicted cell coverage state indicates the predicted cell coverage modification configuration(s) for modification to solve the predicted CCO issue(s) for the corresponding affected cell(s).
         2) A predicted cell deployment status indicator.
         3) Predicted cell replacing information. In some embodiments, “predicted cell deployment status indicator” indicates whether the predicted affected cell(s) needs to be modified at next planned configuration(s). If yes, “predicted cell replacing information” indicates the predicted replacing cell(s) that may replace a part or all of the coverage of the affected cell(s).
      d) One or more predicted SSB(s) in RAN node 202, i.e., SSB index(s) of affected beam(s) in which there is the predicted CCO issue(s).
      e) One or more predicted SSB coverage modification configuration(s) in RAN node 202. For example, each affected SSB has corresponding predicted SSB coverage modification configuration(s). The predicted SSB coverage modification configuration(s) is used to solve the predicted CCO issue(s), and may include at least one of:
         1) A predicted SSB coverage state. In some embodiments, the predicted SSB coverage state indicates the predicted SSB coverage modification configuration(s) for modification to solve the predicted CCO issue(s) for the corresponding affected SSB(s).
         2) A predicted SSB deployment status indicator.
         3) Predicted SSB replacing information. In some embodiments, the predicted SSB deployment status indicator indicates whether the predicted affected SSB(s) needs to be modified at next planned configuration(s). If yes, the predicted SSB replacing information indicates the predicted replacing SSB(s) that may replace a part or all of the coverage of the affected SSB(s).
      f) Predicted validity time for any output in above points a) to e). For example, the predicted validity time for each output in above points a) to e) can be the same or different.
(9) Step 218: RAN node 202 sends the predicted CCO information (i.e., output data of AI/ML based CCO in RAN node 202 in Step 217) to neighbor RAN node 203, e.g., via an existing message (e.g., NG-RAN NODE CONFIGURATION UPDATE message) or a new defined message.
   (a) For example, the predicted CCO information can include at least one of:
      a) One or more predicted CCO issue(s) in RAN node 202 (e.g., coverage or cell edge capacity).
      b) One or more predicted cell(s), i.e., CGI(s), PCI(s) and/or ARFCN(s) of affected cell(s) in which there is the predicted CCO issue(s) in RAN node 202.
      c) One or more predicted cell coverage modification configuration(s). For instance, each affected cell managed by RAN node 202 has corresponding predicted cell coverage modification configuration(s). The predicted cell coverage modification configuration(s) is used to solve the predicted CCO issue(s) in RAN node 202, and may include at least one of:
         1) A predicted cell coverage state.
         2) A predicted cell deployment status indicator.
         3) Predicted cell replacing information.
      d) One or more predicted SSB(s), i.e. SSB index(s) of affected beam(s) in which there is the predicted CCO issue(s) in RAN node 202.
      e) One or more predicted SSB coverage modification configuration(s). For instance, each affected SSB managed by RAN node 202 has corresponding predicted SSB coverage modification configuration(s). The predicted SSB coverage modification configuration(s) is used to solve the predicted CCO issue(s) in RAN node 202, and may include at least one of:
         1) A predicted SSB coverage state.
         2) A predicted SSB deployment status indicator.
         3) Predicted SSB replacing information.
      f) Predicted validity time for any predicted information in above points a) to e). For example, the predicted validity time for each predicted information in above points a) to e) can be the same or different.
(10) Step 219: Neighbor RAN node 203 performs CCO action or adaption based on predicted CCO information received from RAN node 202. For example, RAN node 203 predicts whether there is any CCO issue in RAN node 203 because of predicted CCO issue(s) and/or predicted cell/SSB coverage modification configuration(s) in RAN node 202. If yes, RAN node 203 predicts its cell/SSB coverage modification configuration(s) to solve the predicted CCO issue in RAN node 203. In another example, RAN node 203 predicts its cell/SSB coverage modification configuration(s) to fit to or match with the predicted cell/SSB coverage modification configuration(s) in RAN node 202. The output data of AI/ML based CCO in RAN node 203 can include at least one of:
   (a) One or more predicted CCO issue(s) (e.g., coverage or cell edge capacity) in RAN node 203.
   (b) One or more predicted cell(s), i.e., CGI(s), PCI(s) and/or ARFCN(s) of affected cell(s) in which there is the predicted CCO issue(s) in RAN node 203.
   (c) One or more predicted cell coverage modification configuration(s) in RAN node 203, to fit to or match with the predicted cell/SSB coverage modification configuration(s) in RAN node 202, and/or to solve the predicted CCO issue(s) in RAN node 203. For example, for each affected cell managed by RAN node 203, the predicted cell coverage modification configuration(s) is used to solve the predicted CCO issue(s) predicted by RAN node 203, and/or, to fit to or match with the predicted cell/SSB coverage modification configuration(s) in RAN node 202, and may include at least one of:
      a) A predicted cell coverage state.
      b) A predicted cell deployment status indicator.
      c) Predicted cell replacing Information.
   (d) One or more predicted SSB(s), i.e., SSB index(s) of affected beam(s) in which there is the predicted CCO issue(s) in RAN node 203.
   (e) One or more predicted SSB coverage modification configuration(s) in RAN node 203, to fit to or match with the predicted cell/SSB coverage modification configuration(s) in RAN node 202, and/or to solve the predicted CCO issue(s) in RAN node 203. For example, each affected SSB managed by RAN node 203 has corresponding predicted SSB coverage modification configuration(s). The predicted SSB coverage modification configuration(s) is used to solve the predicted CCO issue(s) predicted by RAN node 203, and/or, to fit to or match with the predicted cell/SSB coverage modification configuration(s) in RAN node 202, and may include at least one of:
      a) A predicted SSB coverage state.
      b) A predicted SSB deployment status indicator.
      c) Predicted SSB replacing information.
   (f) Predicted validity time for any output in above points a) to e). For example, the predicted validity time for each output in above points a) to e) can be the same or different.
(11) Step 220: RAN 202 and/or RAN node 203 sends model performance feedback to OAM 204 if applicable.
   (a) For example, the model performance feedback can include at least one of:
      a) Local resource status information after the predicted cell/SSB coverage modification configuration(s) is adopted.
      b) Local system KPIs (e.g., throughput, delay, or RLF) after the predicted cell/SSB coverage modification configuration(s) is adopted.
      c) Neighbour RAN node's resource status information after the predicted cell/SSB coverage modification configuration(s) is adopted.
      d) Neighbour RAN node's system KPIs (e.g., throughput, delay, or RLF) after the predicted Cell/SSB coverage modification configuration(s) is adopted.
   (b) Based on the received model performance feedback, OAM 204 can perform re-training to update the AI/ML model, and then deploys or updates AI/ML model into RAN node(s), e.g., RAN node 202 and/or RAN node 203.

FIG. 3 illustrates a flow chart of an exemplary procedure 300 of wireless communications in accordance with some embodiments of the present application. The exemplary procedure 300 refers to a procedure in which AI/ML model training for CCO is performed in a RAN node, and AI/ML model inference for CCO is performed in a RAN node. Details described in all other embodiments of the present application are applicable for the embodiments shown in FIG. 3. It should be appreciated by persons skilled in the art that the sequence of the operations in exemplary procedure 300 in FIG. 3 may be changed and some of the operations in exemplary procedure 300 in FIG. 3 may be eliminated or modified, without departing from the spirit and scope of the disclosure.

In the exemplary procedure 300, RAN node 302 or RAN node 303 may be a NG-RAN node. In particular, following steps are performed in the exemplary procedure 300.
(1) Details of Step 310 and Step 311 are the same as those of Step 210 and Step 211 in the exemplary procedure 200 as shown in FIG. 2, respectively.
(2) Step 312: RAN node 303 sends input data for Model Training (e.g., training data) to RAN node 302.
   (a) For instance, the input data for Model Training can include at least one of:
      a) A current resource status.
      b) A historical resource status.
      c) A predicted resource status.
      d) Mobility history information.
   (b) For instance, before RAN node 303 sends input data to RAN node 302, RAN node 303 may receive a request from RAN node 302 that requests RAN node 303 to provide input data for Model Training.
(3) Step 313: AI/ML Model Training is performed at RAN node 302. The measurement result(s) from UE 301 and training input data from RAN node 303 are leveraged to train the AI/ML model. After AI/ML Model Training, RAN node 302 has the AI/ML model.
(4) Details of Step 314 to Step 318 are the same as those of Step 215 to Step 219 in the exemplary procedure 200 as shown in FIG. 2, respectively.
(5) Step 319: RAN node 303 sends model performance feedback to RAN node 302 if applicable.
   (a) For instance, the model performance feedback can include at least one of:
      a) Local resource status information after the predicted cell/SSB coverage modification configuration(s) is adopted.
      b) Local system KPIs (e.g., throughput, delay, or RLF) after the predicted cell/SSB coverage modification configuration(s) is adopted.
      c) Neighbour RAN node's resource status information after the predicted cell/SSB coverage modification configuration(s) is adopted.
      d) Neighbour RAN node's system KPIs (e.g., throughput, delay, or RLF) after the predicted Cell/SSB coverage modification configuration(s) is adopted.
   (b) Based on the received model performance feedback, RAN node 302 can perform re-training to update the AI/ML model, and then deploys or updates AI/ML model.

FIG. 4 illustrates a flow chart of an exemplary procedure 400 of wireless communications in accordance with some embodiments of the present application. Exemplary procedure 400 refers to a CU-DU architecture, and refers to a procedure in which AI/ML model training for CCO is performed in an OAM entity, while AI/ML model inference is performed in a CU and a DU, e.g., a CU predicts CCO issue(s), and a DU predicts cell/SSB coverage modification configuration(s) for solving the predicted CCO issue(s).

Details described in all other embodiments of the present application are applicable for the embodiments shown in FIG. 4. It should be appreciated by persons skilled in the art that the sequence of the operations in exemplary procedure 400 in FIG. 4 may be changed and some of the operations in exemplary procedure 400 in FIG. 4 may be eliminated or modified, without departing from the spirit and scope of the disclosure.

In the exemplary procedure 400, CU 403 or CU 404 may be a gNB-CU, and DU 402 or DU 405 may be a gNB-DU. In particular, following steps are performed in the exemplary procedure 400. DU 402 is any DU managed by CU 403, i.e., DU 402 may be a serving DU or a non-serving DU. DU 405 is any DU managed by CU 404. CU 404 is a neighbour CU of CU 403.
(1) Step 410: AI/ML Model Training is performed at OAM 406. Details of Step 410 can refer to Step 211 to Step 213 in the exemplary procedure 200 as shown in FIG. 2.
(2) Step 411: OAM 406 deploys or updates AI/ML model into gNB-CU(s) and/or gNB-DU(s), for example, DU 402, CU 403, CU 404, and DU 405.
(3) Step 412: DU 402 provides input data for Model Inference (inference input data) to CU 403.
   (a) For instance, the input data for Model Inference from DU 402 can include at least one of:
      a) A current resource status.
      b) A historical resource status.
      c) A predicted resource status if any.
   (b) Before Step 412, DU 402 may receive a request from CU 403 that requests DU 402 to provide the input data for Model Inference.
(4) Step 413: UE 401 provides input data for Model Inference to CU 403.
   (a) For instance, the input data for Model Inference from UE 401 can include at least one of:
      a) UE 401's location information (e.g., coordinates, serving cell ID, moving velocity);
      b) UE 401's Mobility History Information.
      c) UE 401's measurement result(s) (e.g., UE 401's RSRP, RSRQ, SINR measurement, etc.), including cell level and beam level measurement result(s) of UE 401.
      d) A CEF report from UE 401.
      e) An RA report from UE 401.
      f) An RLF report from UE 401.
   (b) Before Step 413, UE 401 may receive a request from CU 403 that requests UE 401 to provide input data for Model Inference. Based on the network request, UE 401 collects and reports to CU 403 the requested inference input.
(5) Step 414: Neighbour DU 405 provides input data for Model Inference to neighbour CU 404.
   (a) For instance, the input data for Model Inference from DU 405 can include at least one of:
      a) A current resource status.
      b) A historical resource status.
      c) A predicted resource status if any.
   (b) Before Step 414, DU 405 may receive a request from CU 404 that requests DU 405 to provide input data for Model Inference.
(6) Step 415: Neighbour CU 404 provides input data for Model Inference to CU 403.
   (a) For instance, the input data for Model Inference from CU 404 can include at least one of:
      a) A current resource status received from DU 405 and/or obtained in CU 404.
      b) A historical resource status received from DU 405 and/or obtained in CU 404
      c) A predicted resource status received from DU 405 and/or obtained in CU 404 if any.
   (b) Before Step 415, CU 404 may receive a request from CU 403 that requests CU 404 to provide input data for Model Inference.
(7) Step 416: CU 403 performs model inference, e.g., based on the inference input from UE 401, the inference input from neighbour CU 404, and its local inference input data.
   (a) For instance, the local inference input data for AI/ML based CCO of CU 403 can include at least one of the following:
      a) A historical resource status.
      b) A current resource status.
      c) A predicted resource status.
      d) A trajectory prediction of UE 401.
      e) Historical traffic of UE 401.
      f) Current traffic of UE 401.
      g) Predicted traffic of UE 401.
      h) Predicted resource status information of neighbor NG-RAN node(s), e.g., CU 404 and/or DU 405.
   (b) In Step 416, CU 403 can predict CCO issue(s) (e.g., coverage or cell edge capacity) together with validity time, predict a set of cell(s) and/or a set of SSB index(es) affected by the predicted CCO issue(s). The output data of AI/ML based CCO generated in/predicted by CU 403 can include at least one of:
      a) One or more predicted CCO issue(s) (e.g., coverage or cell edge capacity).
      b) One or more predicted cell(s), i.e. CGI(s), PCI(s) and/or ARFCN(s) of affected cell(s) in which there is the predicted CCO issue(s).
      c) One or more predicted SSB(s), i.e., SSB index(s) of affected beam(s) in which there is the predicted CCO issue(s).
      d) Predicted validity time for any output in above points a) to c). For instance, the predicted validity time for each output in above points a) to c) can be the same or different.
(8) Step 417: CU 403 sends the predicted CCO information (i.e., output data of AI/ML based CCO generated by CU 403 as mentioned in Step 416) to one or more DUs managed by CU 403, e.g., DU 402 and/or other DU not shown in FIG. The predicted CCO information (i.e., output data of AI/ML based CCO generated by in CU 403 as mentioned in Step 416) may be sent via an existing message (e.g., GNB-CU CONFIGURATION UPDATE message) or a new defined message.
(9) Step 418: DU 402 predicts coverage modification configuration(s) to solve the predicted CCO issue(s). For example, based on the predicted CCO information received from CU 403, DU 402 predicts a set of cell/SSB coverage modification configuration(s) for the affected cell(s)/SSB(s).
   (a) For instance, the output data of AI/ML based CCO predicted in or generated by DU 402 in Step 418 can include at least one of:
      a) One or more predicted cell coverage modification configuration(s). For instance, for any informed affected cell, to solve its corresponding CCO issue(s) predicted in CU 403, DU 402 predicts cell coverage modification configuration(s). The predicted cell coverage modification configuration(s) for any informed affected cell may include: a predicted cell coverage state, a predicted cell deployment status indicator, and/or predicted cell replacing information, which is used to solve the corresponding informed predicted CCO issue(s).
      b) One or more predicted SSB coverage modification configuration(s). For instance, for each informed affected SSB, to solve its corresponding CCO issue(s) predicted in CU 403, DU 402 predicts cell coverage modification configuration(s). The predicted SSB coverage modification configuration(s) for each informed affected SSB may include: a predicted SSB coverage state, a predicted SSB deployment status indicator, and/or predicted SSB replacing information, which is used to solve the corresponding informed predicted CCO issue(s).
      c) Predicted validity time for any output in above points a) and b). For instance, the predicted validity time for each output in above points a) and b) can be the same or different.
(10) Step 419: DU 402 sends the predicted CCO information (i.e., output data of AI/ML based CCO predicted in or generated by DU 402 as mentioned in Step 418) to CU 403, e.g., via an existing message (e.g., GNB-DU CONFIGURATION UPDATE message) or a new defined message.
(11) Step 420: CU 403 sends the predicted CCO information to neighbor CU 404, e.g., via an existing message (e.g., NG-RAN NODE CONFIGURATION UPDATE message) or a new defined message. For example, CU 403 sends the predicted CCO information, that including output data of AI/ML based CCO generated by CU 403 as mentioned in Step 416 and/or the output data of AI/ML based CCO predicted in or generated by DU 402 as mentioned in Step 418, to neighbor CU 404. For another instance, the predicted CCO information can include at least one of:
   (a) One or more predicted CCO issue(s) which may happen in CU 403 or DU 402 (e.g., coverage or cell edge capacity).
   (b) One or more predicted cell(s), i.e., CGI(s), PCI(s) and/or ARFCN(s) of affected cell(s) in which there is the predicted CCO issue(s).
   (c) One or more predicted SSB(s), i.e., SSB index(s) of affected beam(s) in which there is the predicted CCO issue(s).
   (d) One or more predicted cell coverage modification configuration(s). For instance, each informed affected cell managed by CU 403 or DU 402 has corresponding predicted cell coverage modification configuration(s). The predicted cell coverage modification configuration(s) for each informed affected cell is used to solve the corresponding predicted CCO issue, and may include at least one of the following: a predicted cell coverage state, a predicted cell deployment status indicator, and predicted cell replacing information.
   (e) One or more predicted SSB coverage modification configuration(s). For instance, each informed affected SSB managed by CU 403 or DU 402 has corresponding predicted SSB coverage modification configuration(s). The predicted SSB coverage modification configuration(s) for each informed affected SSB is used to solve the corresponding predicted CCO issue(s), and may include: predicted SSB coverage state, predicted SSB deployment status indicator, and/or predicted SSB replacing information.
   (f) Predicted validity time for any predicted information in above points a) to e), the predicted validity time for each predicted information in above points a) to e) can be the same or different.
(12) Step 421: Neighbor CU 404 sends the predicted CCO information to neighbor DU 405, e.g., via an existing message (e.g., GNB-CU CONFIGURATION UPDATE message) or a new defined message. The predicted CCO information can refer to the predicted CCO information mentioned in Step 420.
   (a) After Step 420, i.e., after neighbor CU 404 receives the predicted CCO information from CU 403, it may perform CCO inference. For instance, CU 404 predicts whether there is any CCO issue in CU 404 or DU 405. If yes, CU 404 predicts a set of cell(s) and/or SSB index(es) affected by the predicted CCO issue(s).
      a) For example, the output data of AI/ML based CCO generated in CU 404 can include at least one of:
         1) One or more CCO issue(s) predicted by CU 404 which may happen in CU 404 or DU 405 (e.g., coverage or cell edge capacity).
         2) One or more cell(s) predicted by CU 404, i.e., CGI(s), PCI(s) and/or ARFCN(s) of affected cell(s) in which there is the predicted CCO issue(s) which may happen in CU 404 or DU 405.
         3) One or more SSB(s) predicted by CU 404, i.e., SSB index(s) of affected beam(s) in which there is the predicted CCO issue(s) which may happen in CU 404 or DU 405.
         4) One or more cell coverage modification configuration(s) predicted by CU 404. For instance, for any predicted affected cell, to solve its corresponding CCO issue(s) predicted in CU 404, CU 404 predicts cell coverage modification configuration(s). The predicted cell coverage modification configuration(s) for any affected cell may include: a predicted cell coverage state, a predicted cell deployment status indicator, and/or predicted cell replacing information, which is used to solve the corresponding predicted CCO issue(s).
         5) One or more SSB coverage modification configuration(s) predicted by CU 404. For instance, for each predicted affected SSB, to solve its corresponding CCO issue(s) predicted in CU 404, CU 404 predicts cell coverage modification configuration(s). The predicted SSB coverage modification configuration(s) for each affected SSB may include: a predicted SSB coverage state, a predicted SSB deployment status indicator, and/or predicted SSB replacing information, which is used to solve the corresponding predicted CCO issue(s).
         6) Predicted validity time for any output in above points 1) to 5). For instance, the predicted validity time for each output in above points 1) to 5) can be the same or different.
   (b) In Step 421, neighbor CU 404 may also send the output data of AI/ML based CCO generated in CU 404 as mentioned in above(s) to DU 405, e.g., via an existing message (e.g., GNB-CU CONFIGURATION UPDATE message) or a new defined message.
(13) Step 422: After DU 405 receives the output data of AI/ML based CCO generated by CU 403 as mentioned in Step 416, and/or the output data of AI/ML based CCO predicted in or generated by DU 402 as mentioned in Step 418, and/or the output data of AI/ML based CCO generated in CU 404 in Step 421, DU 405 can predict its own cell/SSB coverage modification configuration(s) to fit to or match with the predicted cell/SSB coverage modification configuration(s) generated by DU 402, or to predict coverage modification configuration(s) to solve the predicted CCO issue(s) which may happen in CU 403 or DU 402, or to predict coverage modification configuration(s) to solve the predicted CCO issue(s) which may happen in CU 404 or DU 405, or to fit to or match with the predicted cell/SSB coverage modification configuration(s) predicted in or generated by CU 404.
(14) Step 423: DU 405 sends the predicted output data of AI/ML based CCO to CU 404.
   (a) For instance, the predicted output data of AI/ML based CCO generated in DU 405 can include at least one of:
      a) One or more cell coverage modification configuration(s) predicted in DU 405. For instance, for each informed affected cell, the DU 405 predicts the corresponding predicted cell coverage modification configuration(s). The predicted cell coverage modification configuration(s) for each cell is used to solve the informed CCO issue(s) predicted by CU 403 and/or CU 404. Or, for each informed cell coverage modification configuration(s) predicted in DU 402 or in CU 404, the DU 405 predicts the corresponding cell coverage modification configuration(s). The cell coverage modification configuration(s) predicted in DU 405 is used to fit to or match with the cell coverage modification configuration(s) predicted in DU 402 or in CU 404. The cell coverage modification configuration(s) predicted in DU 405 may include: a predicted cell coverage state, a predicted dell deployment status indicator, and/or predicted cell replacing information.
      b) One or more SSB coverage modification configuration(s) predicted in DU 405. For instance, for each informed affected SSB, the DU 405 predicts the corresponding predicted SSB coverage modification configuration(s). The predicted SSB coverage modification configuration(s) for each SSB is used to solve the informed CCO issue predicted by CU 403 and/or CU 404. Or, for each informed SSB coverage modification configuration(s) predicted in DU 402 or in CU 404, the DU 405 predicts the corresponding SSB coverage modification configuration(s). The SSB coverage modification configuration(s) predicted in DU 405 is used to fit to or match with the SSB coverage modification configuration(s) predicted in DU 402 or in CU 404. The SSB coverage modification configuration(s) predicted in DU 405 may include: a predicted SSB coverage state, a predicted SSB deployment status indicator, and/or predicted SSB replacing information.
      c) Predicted validity time for any output in above points a) and b), the predicted validity time for each output in above points a) and b) can be same or different
   (b) In Step 423, DU 405 may send the predicted CCO information (i.e., output data of AI/ML based CCO generated in DU 405) to CU 404, e.g., via an existing message (e.g., GNB-DU CONFIGURATION UPDATE message) or a new defined message.
(15) Step 424: DU 402, CU 403, DU 405, and/or CU 404 may send model performance feedback to OAM 406 if applicable.
   (a) The model performance feedback can include at least one of:
      a) Local resource status information after the predicted cell/SSB coverage modification configuration(s) is adopted.
      b) Local system KPIs (e.g., throughput, delay, or RLF) after the predicted cell/SSB coverage modification configuration(s) is adopted.
      c) Neighbour DU's and/or neighbour CU's resource status information after the predicted cell/SSB coverage modification configuration(s) is adopted.
      d) Neighbour DU's and/or neighbour CU's system KPIs (e.g., throughput, delay, or RLF) after the predicted cell/SSB coverage modification configuration(s) is adopted.
   (b) Based on the received model performance feedback, OAM 406 can perform re-training to update the AI/ML model, and then deploys or updates AI/ML model into CU(s) or DU(s).

FIG. 5 illustrates a flow chart of an exemplary procedure 500 of wireless communications in accordance with some embodiments of the present application. Exemplary procedure 500 refers to a CU-DU architecture, and refers to a procedure in which AI/ML model training for CCO is performed in a CU, while AI/ML model inference is performed in a CU and a DU, e.g., a CU predicts CCO issue(s), and a DU predicts cell/SSB coverage modification configuration(s) for solving the predicted CCO issue(s).

Details described in all other embodiments of the present application are applicable for the embodiments shown in FIG. 5. It should be appreciated by persons skilled in the art that the sequence of the operations in exemplary procedure 500 in FIG. 5 may be changed and some of the operations in exemplary procedure 500 in FIG. 5 may be eliminated or modified, without departing from the spirit and scope of the disclosure.

In the exemplary procedure 500, CU 503 or CU 504 may be a gNB-CU, and DU 502 or DU 505 may be a gNB-DU. In particular, following steps are performed in the exemplary procedure 500. DU 502 is any DU managed by CU 503, i.e., DU 502 may be a serving DU or a non-serving DU. DU 505 is any DU managed by CU 504. CU 504 is a neighbour CU of CU 503.
(1) Step 510: AI/ML Model Training is performed at CU 503. Details of Step 510 can refer to Step 311 to Step 313 in the exemplary procedure 300 as shown in FIG. 3.
(2) Step 511: CU 503 deploys or updates AI/ML model into CU(s) (e.g., CU 504) and DU(s) (e.g., DU 502 and/or DU 505).
(3) Details of Step 512 to Step 523 are the same as those of Step 412 to Step 423 in the exemplary procedure 400 as shown in FIG. 4, respectively.
(4) Step 524: DU 502, DU 505, and/or CU 504 may send model performance feedback to CU 503 if applicable.
   (a) For instance, the model performance feedback can include at least one of:
      a) Local resource status information after the predicted cell/SSB coverage modification configuration(s) is adopted.
      b) Local system KPIs (e.g., throughput, delay, or RLF) after the predicted cell/SSB coverage modification configuration(s) is adopted.
      c) Neighbour DU's and/or neighbour CU's resource status information after the predicted cell/SSB coverage modification configuration(s) is adopted.
      d) Neighbour DU's and/or neighbour CU's system KPIs (e.g., throughput, delay, or RLF) after the predicted cell/SSB coverage modification configuration(s) is adopted.
   (b) Based on the received model performance feedback, CU 503 can perform re-training to update the AI/ML model, and then deploys/updates AI/ML model into the CU(s) or DU(s) (e.g., CU 504, DU 502 and/or DU 505).

FIG. 6 illustrates a flow chart of an exemplary procedure 600 of wireless communications in accordance with some embodiments of the present application. Exemplary procedure 600 refers to a CU-DU architecture, and refers to a procedure in which AI/ML model training for CCO is performed in an OAM entity, while AI/ML model inference is performed in a CU, e.g., a CU predicts CCO issue(s) and cell/SSB coverage modification configuration(s) for solving the predicted CCO issue(s).

Details described in all other embodiments of the present application are applicable for the embodiments shown in FIG. 6. It should be appreciated by persons skilled in the art that the sequence of the operations in exemplary procedure 600 in FIG. 6 may be changed and some of the operations in exemplary procedure 600 in FIG. 6 may be eliminated or modified, without departing from the spirit and scope of the disclosure.

In the exemplary procedure 600, CU 603 or CU 604 may be a gNB-CU, and DU 602 or DU 605 may be a gNB-DU. In particular, following steps are performed in the exemplary procedure 600. DU 602 is any DU managed by CU 603, i.e., DU 602 may be a serving DU or a non-serving DU. DU 605 is any DU managed by CU 604. CU 604 is a neighbour CU of CU 603.
(1) Step 610: AI/ML Model Training is performed at OAM 606. Details of Step 610 can refer to Step 211 to Step 213 in the exemplary procedure 200 as shown in FIG. 2.
(2) Step 611: OAM 606 deploys or updates AI/ML model into gNB-CU(s) and gNB-DU(s), e.g., CU 603, CU 604, DU 602 and/or DU 605.
(3) Details of Step 612 to Step 615 are the same as Step 412 to Step 415 in the exemplary procedure 400 as shown in FIG. 4, respectively.
(4) Step 616: CU 603 performs model inference, e.g., based on the inference input from UE 601, the inference input from neighbour CU 604, and its local inference input data. Details for these inputs can refer to Step 416 in the exemplary procedure 400 as shown in FIG. 4.
   (a) In Step 616, CU 603 can predict CCO issue(s) (e.g., coverage or cell edge capacity) together with validity time, predict a set of cell(s), a set of SSB index(es) affected by the predicted CCO issue(s), a set of predict coverage modification configuration(s) to solve the predicted CCO issue(s), e.g., a set of cell/SSB coverage modification configuration(s) for the predicted affected cell(s)/SSB(s). The output data of AI/ML based CCO generated in or predicted by CU 603 can include at least one of:
      a) One or more CCO issue(s) (e.g., coverage or cell edge capacity) predicted by CU 603.
      b) One or more cell(s) predicted by CU 603, i.e., CGI(s), PCI(s) and/or ARFCN(s) of affected cell(s) in which there is the predicted CCO issue(s).
      c) One or more SSB(s) predicted by CU 603, i.e., SSB index(s) of affected beam(s) in which there is the predicted CCO issue(s).
      d) One or more cell coverage modification configuration(s) predicted by CU 603. For instance, for each affected cell managed by CU 603 or DU 602 (which is managed by CU 603), to solve its corresponding CCO issue(s) predicted by CU 603, CU 603 also predicts cell coverage modification configuration(s). The predicted cell coverage modification configuration(s) for any affected cell may include: a predicted cell coverage state, a predicted cell deployment status indicator, and/or predicted cell replacing information.
      e) One or more SSB coverage modification configuration(s) predicted by CU 603. For instance, for each affected SSB, to solve its corresponding CCO issue(s) predicted by CU 603, CU 603 also predicts SSB coverage modification configuration(s). The predicted SSB coverage modification configuration(s) for any affected SSB may include: a predicted SSB coverage state, a predicted SSB deployment status indicator, and/or predicted SSB replacing information.
      f) Predicted validity time for any output in above points a) to e). For instance, the predicted validity time for each output in above points a) to e) can be the same or different.
(5) Step 617: CU 603 sends the predicted CCO information (i.e., output data of AI/ML based CCO generated in or predicted by CU 603 as mentioned in Step 616) to its managed DU(s), e.g., DU 602 and/or a DU not shown in FIG. 6. For example, the predicted CCO information may be sent via an existing message (e.g., GNB-CU CONFIGURATION UPDATE message) or a new defined message.
(6) Step 618: CU 603 sends the predicted CCO information (i.e., output data of AI/ML based CCO generated in or predicted by CU 603 as mentioned in Step 616) to neighbor CU 604, e.g., via an existing message (e.g., NG-RAN NODE CONFIGURATION UPDATE message) or a new defined message.
(7) Step 619: Neighbor CU 604 transfers the predicted CCO information received from CU 603 (i.e., output data of AI/ML based CCO generated in or predicted by CU 603 as mentioned in Step 616) to its managed DU(s), e.g., DU 605 and/or a DU not shown in FIG. DU 605. For example, the predicted CCO information may be sent via an existing message (e.g., GNB-CU CONFIGURATION UPDATE message) or a new defined message.
(8) After Step 619, there may be following two options in different embodiments of the exemplary procedure 600, i.e., Option 1 or Option 2. The sequences of Step 619 and Step 620 are not fixed and may be varied in different embodiments. Steps 621 and 622 are performed in Option 1, but not performed in Option 2, and thus are optional as shown in FIG. 6.
   Option 1: Steps 620, 619, and 621 to 623 are performed.
      a) Step 620: After CU 604 receives the predicted CCO information from CU 603 in Step 618, CU 604 may perform CCO inference. For example, CU 604 predicts whether there is any CCO issue in CU 604 or DU 605. If yes, CU 604 predicts a set of cell(s) and/or SSB index(es) affected by the predicted CCO issue(s). Then, CU 604 also transmits output data of AI/ML based CCO predicted in CU 604 to its managed DU(s) (e.g., DU 605 and/or a DU not shown in FIG. 6) in Step 619. The output data of AI/ML based CCO predicted in CU 604 in Step 620 (e.g., which is named as the 3rd output data of AI/ML based CCO) can include at least one of:
         1) One or more CCO issue(s) predicted by CU 604 which may happen in CU 604 or DU 605 (e.g., coverage or cell edge capacity).
         2) One or more set of cell(s) predicted by CU 604, i.e., CGI(s), PCI(s) and/or ARFCN(s) of affected cell(s) in which there is the predicted CCO issue(s) which may happen in CU 604 or DU 605.
         3) One or more set of SSB(s) predicted by CU 604, i.e., SSB index(s) of affected beam(s) in which there is the predicted CCO issue(s) which may happen in CU 604 or DU 605.
         4) One or more cell coverage modification configuration(s) predicted by CU 404. For instance, for any affected cell, to solve its corresponding CCO issue(s) predicted in CU 404, CU 404 predicts cell coverage modification configuration(s). The predicted cell coverage modification configuration(s) for any affected cell may include: a predicted cell coverage state, a predicted cell deployment status indicator, and/or predicted cell replacing information, which is used to solve the corresponding predicted CCO issue(s).
         5) One or more SSB coverage modification configuration(s) predicted by CU 404. For instance, for each affected SSB, to solve its corresponding CCO issue(s) predicted in CU 404, CU 404 predicts cell coverage modification configuration(s). The predicted SSB coverage modification configuration(s) for each affected SSB may include: a predicted SSB coverage state, a predicted SSB deployment status indicator, and/or predicted SSB replacing information, which is used to solve the corresponding predicted CCO issue(s).
         6) Predicted validity time for any output in above points 1) to 5). For example, the predicted validity time for each output in above points 1) to 5) can be the same or different.
      b) In Step 619, CU 604 further transmits the 3rd output data of AI/ML based CCO to its managed DU(s) (e.g., DU 605 and/or a DU not shown in FIG. 6), e.g., via an existing message (e.g., GNB-CU CONFIGURATION UPDATE message) or a new defined message.
      c) Details of Step 621 to Step 623 are the same as Step 422 to Step 424 in the exemplary procedure 400 as shown in FIG. 4, respectively. For example, in Step 621, DU 605 can predict its own cell/SSB coverage modification configuration(s) to fit to or match with the predicted cell/SSB coverage modification configuration(s) generated by DU 602, or to predict coverage modification configuration(s) to solve the predicted CCO issue(s) which may happen in CU 603 or DU 602, or to predict coverage modification configuration(s) to solve the predicted CCO issue(s) which may happen in CU 604 or DU 605, or to fit to or match with the predicted cell/SSB coverage modification configuration(s) predicted in or generated by CU 604. In Step 622, DU 605 may send the predicted CCO information (i.e., output data of AI/ML based CCO generated in DU 605, including, e.g., cell coverage modification configuration(s) predicted in DU 605, SSB coverage modification configuration(s) predicted in DU 605, and/or predicted validity time) to CU 604.
   Option 2: Steps 620, 619, and 623 are performed.
      a) Step 620: In addition to predicting the same output data of AI/ML based CCO in Step 620 of Option 1 (i.e., the 3rd output data of AI/ML based CCO), CU 604 also predicts following output data of AI/ML based CCO (e.g., which is named as the 4th output data of AI/ML based CCO). CU 604 may also predict how to solve the predicted CCO issue(s) which may happen predicted in CU 604 or a DU managed by CU 604 (e.g., DU 605). For instance, the output data of AI/ML based CCO generated in or predicted by CU 604 (i.e., the 4th output data of AI/ML based CCO) can include at least one of:
         1) One or more cell coverage modification configuration(s) predicted by CU 604. For example, for each cell affected by the predicted CCO issue which may happen in CU 604 or DU 605, CU 604 also predicts corresponding cell coverage modification configuration(s) to solve the predicted CCO issue(s). The predicted cell coverage modification configuration(s) for any affected cell and may include: a predicted cell coverage state, a predicted cell deployment status indicator, and/or predicted cell replacing information.
         2) One or more SSB coverage modification configuration(s) predicted by CU 604. For instance, for each SSB, affected by the predicted CCO issue which may happen, CU 604 also predicts SSB coverage modification configuration(s) to solve the predicted CCO issue(s). The predicted SSB coverage modification configuration(s) for any affected SSB may include: a predicted SSB coverage state, a predicted SSB deployment status indicator, and/or predicted SSB replacing information.
         3) Predicted validity time for any output in above points 1) and 2). For example, the predicted validity time for each output in above points 1) and 2) can be the same or different
      b) In Step 619, CU 604 further transmits both the 3rd output data of AI/ML based CCO and the 4th output data of AI/ML based CCO to its managed DU(s) (e.g., DU 605 and/or a DU not shown in FIG. 6), e.g., via an existing message (e.g., GNB-CU CONFIGURATION UPDATE message) or a new defined message.
      c) Details of Step 623 are the same as those of Step 424 in the exemplary procedure 400 as shown in FIG. 4.
   The transmitting sequence of data in Step 619 is not fixed and may be varied according to different embodiments. For example, in Option 1 or Option 2, “the time instance when CU 604 transfers the predicted CCO information received from CU 603 (i.e., output data of AI/ML based CCO generated in/predicted by CU 603 as mentioned in Step 616) to its managed DU(s) (e.g., DU 605)” and “the time instance when CU 604 transfers the 3rd output data of AI/ML based CCO, and/or 4th output data of AI/ML based CCO to its DU managed DU(s) (e.g., DU 605)” is not fixed and may be varied according to different embodiments.
      a) In an embodiments, CU 604 firstly transfers “the predicted CCO information received from CU 603 (i.e., output data of AI/ML based CCO generated in/predicted by CU 603 as mentioned in Step 616) to its managed DU(s) (e.g., DU 605)”, and then transfers “the 3rd output data of AI/ML based CCO, and/or 4th output data of AI/ML based CCO to its DU managed DU(s) (e.g., DU 605)”.
      b) In a further embodiments, CU 604 firstly transfers “the 3rd output data of AI/ML based CCO, and/or 4th output data of AI/ML based CCO to its DU managed DU(s) (e.g., DU 605)”, and then transfers “the predicted CCO information received from CU 603 (i.e., output data of AI/ML based CCO generated in/predicted by CU 603 as mentioned in Step 616) to its managed DU(s) (e.g., DU 605)”.
      c) In another embodiments, CU 604 simultaneously transfers “the 3rd output data of AI/ML based CCO, and/or 4th output data of AI/ML based CCO to its DU managed DU(s) (e.g., DU 605)” and “the predicted CCO information received from CU 603 (i.e., output data of AI/ML based CCO generated in/predicted by CU 603 as mentioned in Step 616) to its managed DU(s) (e.g., DU 605)”.

FIG. 7 illustrates a flow chart of an exemplary procedure 700 of wireless communications in accordance with some embodiments of the present application. Exemplary procedure 700 refers to a CU-DU architecture, and refers to a procedure in which AI/ML model training for CCO is performed in a CU, and AI/ML model inference is also performed in the CU, e.g., the CU predicts CCO issue(s) and cell/SSB coverage modification configuration(s) for solving the predicted CCO issue(s).

Details described in all other embodiments of the present application are applicable for the embodiments shown in FIG. 7. It should be appreciated by persons skilled in the art that the sequence of the operations in exemplary procedure 700 in FIG. 7 may be changed and some of the operations in exemplary procedure 700 in FIG. 7 may be eliminated or modified, without departing from the spirit and scope of the disclosure.

In the exemplary procedure 700, CU 703 or CU 704 may be a gNB-CU, and DU 702 or DU 705 may be a gNB-DU. In particular, following steps are performed in the exemplary procedure 700. DU 702 is any DU managed by CU 703, i.e., DU 702 may be a serving DU or a non-serving DU. DU 705 is any DU managed by CU 704. CU 704 is a neighbour CU of CU 703.
(1) Step 710: AI/ML Model Training is performed at CU 703. Details of Step 710 can refer to Step 311 to Step 313 in the exemplary procedure 300 as shown in FIG. 3.
(2) Step 711: CU 703 deploys or updates AI/ML model into gNB-CU(s) (e.g., CU 704) and gNB-DU(s) (e.g., DU 702 and DU 705).
(3) Details of Step 712 to Step 715 are the same as those of Step 412 to Step 415 in the exemplary procedure 400 as shown in FIG. 4, respectively.
(4) Details of Step 716 to Step 722 are the same as those of Step 616 to Step 622 in the exemplary procedure 600 as shown in FIG. 6, respectively. Steps 721 and 722 are performed in Option 1, but not performed in Option 2, and thus are optional as shown in FIG. 7.
(5) Details of Step 723 are the same as those of Step 524 in the exemplary procedure 500 as shown in FIG. 5.

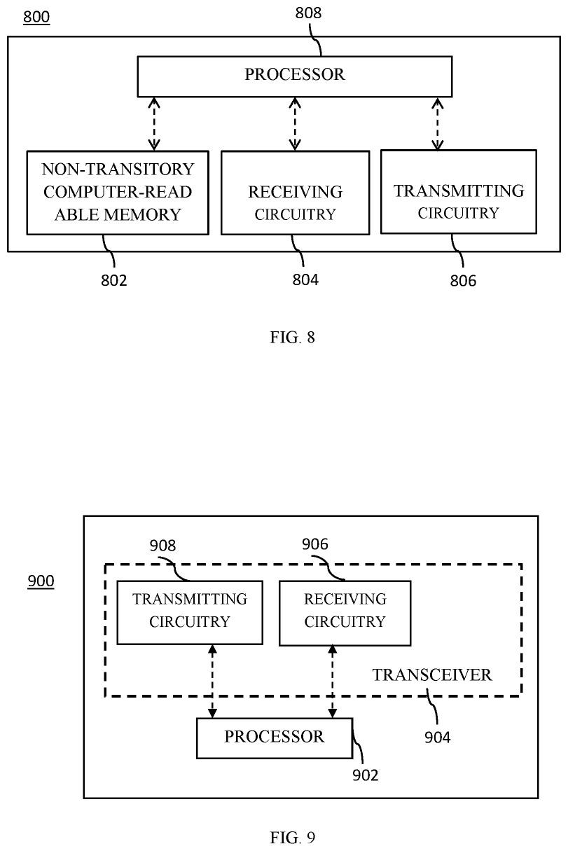

FIG. 8 illustrates an exemplary block diagram of an apparatus 800 for an AI/ML based CCO mechanism in accordance with some embodiments of the present application.

As shown in FIG. 8, the apparatus 800 may include at least one non-transitory computer-readable medium 802, at least one receiving circuitry 804, at least one transmitting circuitry 806, and at least one processor 808 coupled to the non-transitory computer-readable medium 802, the receiving circuitry 804 and the transmitting circuitry 806. The at least one processor 808 may be a CPU, a DSP, a microprocessor etc. The apparatus 800 may be a network device (e.g., a RAN node, or a CU, or a DU) configured to perform a method illustrated in the above or the like.

Although in this figure, elements such as the at least one processor 808, receiving circuitry 804, and transmitting circuitry 806 are described in the singular, the plural is contemplated unless a limitation to the singular is explicitly stated. In some embodiments of the present application, the receiving circuitry 804 and the transmitting circuitry 806 can be combined into a single device, such as a transceiver. In certain embodiments of the present application, the apparatus 800 may further include an input device, a memory, and/or other components.

In some embodiments of the present application, the non-transitory computer-readable medium 802 may have stored thereon computer-executable instructions to cause a processor to implement the method with respect to a network device (e.g., a RAN node, or a CU, or a DU) as described above. For example, the computer-executable instructions, when executed, cause the processor 808 interacting with receiving circuitry 804 and transmitting circuitry 806, so as to perform the steps with respect to a network device (e.g., a RAN node, or a CU, or a DU) as illustrated above.

FIG. 9 illustrates a further exemplary block diagram of an apparatus for an AI/ML based CCO mechanism in accordance with some embodiments of the present application. Referring to FIG. 9, the apparatus 900 may include at least one processor 902 and at least one transceiver 904 coupled to the at least one processor 902. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some embodiments of the present application, when the apparatus 900 is a network device (e.g., a RAN node or a CU), the processor 902 is configured: to obtain inference input data associated with CCO; to perform an inference operation of a processing model for CCO based on the inference input data; and to generate output data of the inference operation of the processing model for CCO.

According to some embodiments of the present application, when the apparatus 900 is a network device (e.g., a neighbour RAN node or a neighbour CU), the processor 902 is configured: to receive at least one of output data of CCO or further output data of CCO via the transceiver 904 from a neighbour network device or from a neighbour CU. The output data of CCO is associated with an inference operation of a processing model of the neighbour network device or the neighbour CU. The further output data of CCO is associated with the inference operation of the processing model of the neighbour network device or the neighbour CU, or associated with an inference operation of a processing model of a DU managed by the neighbour CU.

According to some other embodiments of the present application, when the apparatus 900 is a DU, the processor 902 is configured to receive output data of CCO via the transceiver 904 from a CU. The DU is managed by the CU, and the output data of CCO is associated with an inference operation of a processing model of the CU.

According to some other embodiments of the present application, when the apparatus 900 is a DU, the processor 902 is configured to receive at least one of output data of CCO or further output data of the CCO via the transceiver 904 from a CU. The DU is managed by the CU. The output data of CCO is associated with an inference operation of a processing model of a neighbour network device or a neighbour CU. The further output data of CCO is associated with the inference operation of the processing model of the neighbour network device or the neighbour CU, or associated with an inference operation of a processing model of a DU managed by the neighbour CU.

The method(s) of the present application can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present application.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A network device, comprising:
at least one memory; and
at least one processor coupled with the at least one memory and configured to cause the network device to:
obtain inference input data associated with capacity and coverage optimization (CCO);
perform an inference operation of a processing model for the CCO based on the inference input data; and
generate first output data of the inference operation of the processing model for the CCO.

2. The network device of claim 1, wherein the first output data includes at least one of:
a set of first CCO issues predicted by the network device;
a set of first predicted cells in which there is an issue within the set of first CCO issues;
a set of first predicted synchronization signal blocks (SSBs) in which there is the issue within the set of first CCO issues;
a first predicted validity time for an issue within the set of first CCO issues;
a second predicted validity time for a cell within the set of first predicted cells; or
a third predicted validity time for a SSB within the set of first predicted SSBs.

3. The network device of claim 2, wherein the issue within the set of first CCO issues is related to at least one of coverage of the cell within the set of first predicted cells, or a cell edge capacity of the cell within the set of first predicted cells.

4. The network device of claim 1, wherein the at least one processor is configured to cause the network device to generate second output data of the inference operation of the processing model for the CCO.

5. The network device of claim 4, wherein the network device is a centralized unit (CU), and wherein the at least one processor is configured to cause the CU to transmit at least one of the first output data or the second output data to a distributed unit (DU) managed by the CU.

6. The network device of claim 4, wherein the at least one processor is configured to cause the network device to transmit at least one of the first output data or the second output data to a neighbor network device or a neighbor centralized unit (CU).

7. The network device of claim 1, wherein the network device is a centralized unit (CU), and wherein the at least one processor is configured to cause the CU to:
transmit the first output data to a distributed unit (DU) managed by the CU; and
receive second output data from the DU managed by the CU.

8. The network device of claim 7, wherein the second output data includes at least one of:
a set of first predicted cell coverage modification configurations;
a set of first predicted synchronization signal block (SSB) coverage modification configurations;
a first predicted validity time for a configuration within the set of first predicted cell coverage modification configurations; or
a second predicted validity time for the configuration within the set of first predicted SSB coverage modification configurations.

9. A distributed unit (DU), comprising:
at least one memory; and
at least one processor configured to cause the DU to receive first output data of capacity and coverage optimization (CCO) from a centralized unit (CU), wherein the DU is managed by the CU, and wherein the first output data of the CCO is associated with an inference operation of a processing model of the CU.

10. The DU of claim 9, wherein the first output data of the CCO includes at least one of:
a set of first CCO issues predicted by the CU;
a set of first predicted cells in which there is an issue within the set of first CCO issues;
a set of first predicted synchronization signal blocks (SSBs) in which there is the issue within the set of first CCO issues;
a first predicted validity time for the issue within the set of first CCO issues;
a second predicted validity time for a cell within the set of first predicted cells; or
a third predicted validity time for a SSB within the set of first predicted SSBs.

11. The DU of claim 9, wherein the at least one processor is configured to cause the DU to receive second output data of the CCO from the CU, wherein the second output data of the CCO is associated with the inference operation of the processing model of the CU, and wherein the second output data of the CCO includes at least one of:
a set of first predicted cell coverage modification configurations;
a set of first predicted synchronization signal block (SSB) coverage modification configurations;
a first predicted validity time for a cell within the set of first predicted cell coverage modification configurations; or
a second predicted validity time for a SSB within the set of first predicted SSB coverage modification configurations.

12. The DU of claim 11, wherein the at least one processor is configured to cause the DU to:
perform an inference operation of a processing model for the CCO; and
generate third output data of the CCO.

13. The DU of claim 12, wherein the at least one processor is configured to cause the DU to transmit the third output data of the CCO to the CU, and wherein the third output data of the CCO is associated with the inference operation of the processing model of the CU.

14. The DU of claim 12, wherein the third output data of the CCO includes at least one of:
a set of second predicted cell coverage modification configurations predicted by the DU;
a set of second predicted SSB coverage modification configurations predicted by the DU;
a fourth predicted validity time for a cell within the set of second predicted cell coverage modification configurations; or
a fifth predicted validity time for a SSB within the set of second predicted SSB coverage modification configurations.

15. A method performed by a distributed unit (DU), the method comprising:
receiving at least one of first output data of capacity and coverage optimization (CCO) or second output data of the CCO from a centralized unit (CU),
wherein the DU is managed by the CU, wherein the first output data of the CCO is associated with an inference operation of a processing model of a neighbor network device or a neighbor CU, and wherein the second output data of the CCO is associated with the inference operation of the processing model of the neighbor network device or the neighbor CU or associated with an inference operation of a processing model of a distributed unit (DU) managed by the neighbor CU.

16. A processor for wireless communication, comprising:
at least one controller coupled with at least one memory and configured to cause the processor to:
obtain inference input data associated with capacity and coverage optimization (CCO);
perform an inference operation of a processing model for the CCO based on the inference input data; and
generate first output data of the inference operation of the processing model for the CCO.

17. The processor of claim 16, wherein the first output data includes at least one of:
a set of first CCO issues predicted by a network device;
a set of first predicted cells in which there is an issue within the set of first CCO issues;
a set of first predicted synchronization signal blocks (SSBs) in which there is the issue within the set of first CCO issues;
a first predicted validity time for an issue within the set of first CCO issues;
a second predicted validity time for a cell within the set of first predicted cells; or
a third predicted validity time for a SSB within the set of first predicted SSBs.

18. The processor of claim 17, wherein the issue within the set of first CCO issues is related to at least one of coverage of the cell within the set of first predicted cells, or a cell edge capacity of the cell within the set of first predicted cells.

19. The processor of claim 16, wherein the at least one controller is configured to cause the processor to generate second output data of the inference operation of the processing model for the CCO.

20. The processor of claim 16, wherein the at least one controller is configured to cause the processor to transmit at least one of the first output data or the second output data to a distributed unit (DU) managed by a centralized unit (CU).
